(19) United States
(12) Patent Application Publication
(10) Pub. No.: US 2026/0234300 A1
(43) Pub. Date: Aug. 13, 2026

(54) Catalysts for Copolymerizations

(71) Applicant: ExxonMobil Technology and Engineering Company, Spring, TX (US)

(72) Inventors: Alexander V. Zabula, Seabrook, TX (US); Torin J. Dupper, Houston, TX (US); Michelle E. Titone, La Porte, TX (US); Jo Ann M. Canich, Houston, TX (US); Carlos R. Lopez-Barron, Houston, TX (US); Tzu-Pin Lin, Houston, TX (US); Sarah J Mattler, League City, TX (US); Georgy P. Goryunov, Moscow (RU); Dmitry Uborsky, Moscow (RU); Alexander Z. Voskoboynikov, Moscow (RU)

(21) Appl. No.: 19/153,564

(22) PCT Filed: Jan. 12, 2024
(86) PCT No.: PCT/US2024/011400

§ 371 Date: Aug. 4, 2025

Related U.S. Application Data
(60) Provisional application No. 63/483,869, filed on Feb. 8, 2023.

(51) Int. Cl. C08F 10/02; B60C 1/00; C08F 36/06; C08K 3/36

(52) U.S. Cl. CPC C08F 10/02; B60C 1/0016; C08F 36/06; C08K 3/36

(57) ABSTRACT

The current disclosure relates to catalyst compounds, catalyst systems containing such compounds, and uses thereof. In some embodiments, a process for producing an ethylene copolymer, the process includes polymerizing ethylene and a comonomer selected from the group consisting of C₃-C₂₂ alpha-olefin, C₄-C₄₀ conjugated diene, C₅-C₂₀ cyclic olefin, C₆-C₆₀ metal hydrocarbenyl transfer agent, and combinations thereof by introducing the ethylene, a chain transfer agent, and the optional comonomer with a catalyst system, in a reactor, at a reactor pressure of 0.05 MPa to 1,500 MPa and a reactor temperature of 30° C. to 230° C. to form the ethylene copolymer. The catalyst system includes a compound is represented by Formula (I) where M is a group 3 transition metal or a lanthanide metal.

### CROSS-REFERENCE TO RELATED APPLICATIONS

This application claims the benefit of and priority to U.S. Provisional Application No. 63/483,869 filed Feb. 8, 2023, the disclosure of which is incorporated herein by reference.

### FIELD

The current disclosure relates to catalyst compounds, catalyst systems containing such compounds, and uses thereof.

### BACKGROUND

Copolymers of olefins and conjugated dienes demonstrate properties that are beneficial in the tire industry—e.g. aging resistance, puncture performance, reparability, rolling resistance, and wear resistance. Copolymers formed from ethylene and butadiene monomers have been shown to improve such properties when incorporated into one or more of the components of the tires. However, the copolymerization of ethylene and butadiene can be challenging, as the difference in reaction mechanism and relative reactivity between these two monomers differ such that developing highly efficient methods of producing high molecular weight ethylene-butadiene random copolymers is difficult.

To overcome these difficulties, current efforts have focused on developing methods that implement catalyst systems that are tolerant of both monomers and capable of copolymerization of both monomers within the same process window. Example catalytic systems based on halogenated complexes of transition metals, such as titanium, have provided copolymerization of ethylene and a conjugated diene. Japanese patent specifications JP-10237131A, JP-09316118A and JP-11171930A disclose copolymers of ethylene and butadiene in which the butadiene may be inserted in the form of cis-cyclopentyl and trans-cyclopentyl linkages. These copolymers are obtained by a catalytic system comprising dimethylsilyl (pentamethylcyclopentadienyl)(t-butylamide)titanium dichloride and methylalumoxane.

Considering the interest in copolymers of olefins and conjugated dienes expressed by the tire industry over the last decade, the development of highly active catalyst is necessary for the production of these elastomers at the industrial scale. Currently, the lack of an active and cost-competitive catalyst is the main obstacle to the wide commercialization of corresponding new copolymers.

There is a need for catalyst systems capable of polymerizing mono-olefins and conjugated dienes at high activity (e.g., within the same process window) to provide commercially scalable polymerizations (e.g., high activity under mild conditions).

References for citing in an Information Disclosure Statement (37 C.F.R. 1.97(h)) can include: U.S. Pat. Nos. 11,214,634; 11,203,654; 11,248,070; 11,254,763; 5,191,052; 8,962,744; 9,139,680; 10,030,092; 9,181,376; 9,670,302; 9,056,936; 8,969,496; 10,457,765; 10,844,149; 10,822,475; 8,039,565; 11,155,656; 11,136,422; 11,254,804; 11,286,369; 7,547,654; 10,752,712; U.S. Patent Publication Nos. 2017/0073450; 2022/0135717; PCT Publications: WO 2021/155168; WO 2021/155158; WO 2017/097831; WO 2022/112699; WO 2022/106769; WO 2021/053294; WO 2021/023924; WO 2020/128249; WO 2022/112700; WO 2022/112692; WO 2022/112690; WO 2022/112691; WO 2020/070443; Foreign Patents: JP5656686; JP5675434; JP2013155360; JP2013147567; JP5612511; JP2013159626; EP3988583; FR3108610; CN113307901; Journal articles: Macromolecules, 2021, 54, 20, pp. 9445-9451.

### SUMMARY

The current disclosure relates to catalyst compounds, catalyst systems containing such compounds, and uses thereof.

In some embodiments, a process for producing an ethylene copolymer includes polymerizing ethylene and an optional comonomer selected from the group consisting of C₃-C₂₂ alpha-olefin, C₄-C₄₀ conjugated diene, C₅-C₂₀ cyclic olefin, C₆-C₆₀ metal hydrocarbenyl transfer agent, and combinations thereof by introducing the ethylene, a chain transfer agent, and the optional comonomer with a catalyst system, in a reactor, at a reactor pressure of 0.05 MPa to 1,500 MPa and a reactor temperature of 30° C. to 230° C. to form the ethylene copolymer. The catalyst system includes compound is represented by Formula (I):

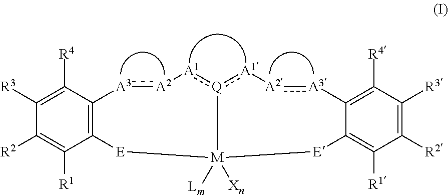

wherein:
   M is a group 3 transition metal or a lanthanide metal;
   E and E′ are each independently oxygen, sulfur, or NR^{A}, wherein R^{A} is independently hydrogen, C₁-C₄₀ hydrocarbyl, substituted C₁-C₄₀ hydrocarbyl, or a heteroatom-containing group;
   Q is a group 14 atom, group 15 atom, or group 16 atom;
   A¹QA^{1′} are part of a heterocyclic Lewis base containing 4 to 40 non-hydrogen atoms that links A² to A^{2′} via a 3-atom bridge with Q being central atom of the 3-atom bridge;
   each of A¹ and A^{1′} is independently carbon, nitrogen, or C(R^{B}), wherein R^{B} is selected from hydrogen, C₁-C₂₀ hydrocarbyl, and substituted C₁-C₂₀ hydrocarbyl;

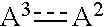

is a divalent group containing 2 to 40 non-hydrogen atoms that links A¹ to the E-bonded aryl group shown in Formula (I) via a 2-atom bridge, and A³ and A² are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;

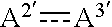

is a divalent group containing 2 to 40 non-hydrogen atoms that links A^{1′} to the E′-bonded aryl group shown in Formula (I) via a 2-atom bridge, and A^{3′} and A^{2′} are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;
each L is independently a Lewis base;
X is an anionic ligand;
any two or more L groups may be joined together to form a polydentate Lewis base;
an X group may be joined to an L group to form a monoanionic bidentate group;
n is 1;
m is 0, 1, or 2;
n+m is not greater than 3; and
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In some embodiments, the present disclosure provides a catalyst system including an activator and a catalyst compound of the present disclosure.

In some embodiments, a tire includes a composition. The composition includes about 10 pounds per hundred rubber (phr) to about 150 phr filler. The composition includes a copolymer having: ethylene units, conjugated diene units, about 0.1 mol % to about 10 mol % 1,2-cyclopentane units, and functionalized vinyl transfer agent units.

### DETAILED DESCRIPTION

The present disclosure provides bis(phenolate)-type catalyst systems based on Group 3 elements or rare earth elements which can be used for producing copolymers of ethylene and conjugated dienes under mild conditions with high conversions. The catalyst systems disclosed herein are attractive options for implementation into industrial scale processes for the high throughput production of copolymer materials, e.g., copolymers derived from ethylene and butadiene monomers, having tailorable physical properties, polymer backbone architecture, and varying functional moieties. In addition, polar side chain moieties can be incorporated into the polymer chains over the course of copolymerization. Such functionalized polymers can be desirable for the tire industry due to enhanced interactions between the copolymer(s) and filler(s) present with the copolymer(s) during use as a tire material. Because polar side chain moieties can be incorporated along the backbone of copolymers of the present disclosure (instead of merely as end-group functionalities), the amount polar side chain moieties can be increased (as compared to copolymers merely having end-group functionalities), allowing a reduced amount of filler(s) incorporated into compositions used as tire material.

### Definitions

The new numbering scheme for the Periodic Table Groups is used as described in Chemical and Engineering News, v. 63(5), pg. 27 (1985). Therefore, a “group 3 metal” is an element from group 3 of the Periodic Table, e.g. Sc, Y, or Nd.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

Ethylene shall be considered an α-olefin.

Unless otherwise specified, the term “Cₙ” means hydrocarbon(s) having n carbon atom(s) per molecule, wherein n is a positive integer.

The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Hydrocarbyls may be C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like, aryl groups, such as phenyl, benzyl, naphthalenyl, and the like.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂—OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂—OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

The term “substituted aromatic,” means an aromatic group having 1 or more hydrogen groups replaced by a hydrocarbyl, substituted hydrocarbyl, heteroatom or heteroatom containing group.

A “substituted phenolate” is a phenolate group where at least one, two, three, four or five hydrogen atoms in the 2, 3, 4, 5, and/or 6 positions has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), where the 1 position is the phenolate group (Ph-O—, Ph-S—, and Ph-N(R\hat{ })—groups, where R\hat{ } is hydrogen, C₁-C₄₀ hydrocarbyl, C₁-C₄₀ substituted hydrocarbyl, a heteroatom or a heteroatom-containing group). For example, a “substituted phenolate” group in the catalyst compounds described herein is represented by the formula:

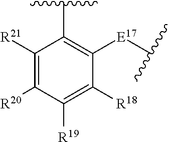

where R¹⁸ is hydrogen, C₁-C₄₀ hydrocarbyl (such as C₁-C₄₀ alkyl) or C₁-C₄₀ substituted hydrocarbyl, a heteroatom or a heteroatom-containing group, E¹⁷ is oxygen, sulfur, or NR¹⁷, and each of R¹⁷, R¹⁹, R²⁰, and R²¹ is independently selected from hydrogen, C₁-C₄₀ hydrocarbyl (such as C₁-C₄₀ alkyl) or C₁-C₄₀ substituted hydrocarbyl, a heteroatom or a heteroatom-containing group, or two or more of R¹⁸, R¹⁹, R²⁰, and R²¹ are joined together to form a C₄-C₆₂ cyclic or polycyclic ring structure, or a combination thereof, and the wavy line shows where the substituted phenolate group forms bonds to the rest of the catalyst compound. At least one of R¹⁸, R¹⁹, R²⁰, and/or R²¹ is not hydrogen.

An “alkyl substituted phenolate” is a phenolate group where at least one, two, three, four or five hydrogen atoms in the 2, 3, 4, 5, and/or 6 positions has been replaced with at least one alkyl group, such as a C₁ to C₄₀, alternately C₂ to C₂₀, alternately C₃ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, adamantanyl and the like including their substituted analogues.

An “aryl substituted phenolate” is a phenolate group where at least one, two, three, four or five hydrogen atoms in the 2, 3, 4, 5, and/or 6 positions has been replaced with at least one aryl group, such as a C₁ to C₄₀, alternately C₂ to C₂₀, alternately C₃ to C₁₂ aryl group, such as phenyl, 4-fluorophenyl, 2-methylphenyl, 2-propylphenyl, 2,6-dimethylphenyl, mesityl, 2-ethylphenyl, naphthalenyl, and the like including their substituted analogues.

The term “ring atom” means an atom that is part of a cyclic ring structure. By this definition, a benzyl group has six ring atoms and tetrahydrofuran has 5 ring atoms.

A heterocyclic ring, also referred to as a heterocycle, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, substituted hydrocarbyl, heteroatom or heteroatom containing group.

A substituted hydrocarbyl ring means a ring comprised of carbon and hydrogen atoms having 1 or more hydrogen groups replaced by a hydrocarbyl, substituted hydrocarbyl, heteroatom or heteroatom containing group.

For purposes of the present disclosure, in relation to catalyst compounds (e.g., substituted bis(phenolate) catalyst compounds), the term “substituted” means that a hydrogen group has been replaced with a hydrocarbyl group, a heteroatom or heteroatom-containing group, such as halogen (such as Br, C₁, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

A tertiary hydrocarbyl group possesses a carbon atom bonded to three other carbon atoms. When the hydrocarbyl group is an alkyl group, tertiary hydrocarbyl groups are also referred to as tertiary alkyl groups. Examples of tertiary hydrocarbyl groups include tert-butyl, 2-methylbutan-2-yl, 2-methylhexan-2-yl, 2-phenylpropan-2-yl, 2-cyclohexylpropan-2-yl, 1-methylcyclohexyl, 1-adamantanyl, bicyclo[2.2.1]heptan-1-yl and the like. Tertiary hydrocarbyl groups can be illustrated by the formula:

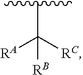

wherein R^{A}, R^{B} and R^{C} are independently hydrocarbyl groups or substituted hydrocarbyl groups that may optionally be bonded to one another, and the wavy line shows where the tertiary hydrocarbyl group forms bonds to other groups.

A tertiary hydrocarbyl group can be a cyclic tertiary hydrocarbyl group. Cyclic tertiary hydrocarbyl group is defined as a tertiary hydrocarbyl group that forms at least one alicyclic (non-aromatic) ring. Cyclic tertiary hydrocarbyl groups are also referred to as alicyclic tertiary hydrocarbyl groups. When the hydrocarbyl group is an alkyl group, cyclic tertiary hydrocarbyl groups are also referred to as cyclic tertiary alkyl groups or alicyclic tertiary alkyl groups. Examples of cyclic tertiary hydrocarbyl groups include 1-adamantanyl, 1-methylcyclohexyl, 1-methylcyclopentyl, 1-methylcyclooctyl, 1-methylcyclodecyl, 1-methylcyclododecyl, bicyclo[3.3.1]nonan-1-yl, bicyclo[2.2.1]heptan-1-yl, bicyclo[2.3.3]hexan-1-yl, bicycle[1.1.1]pentan-1-yl, bicycle[2.2.2]octan-1-yl, and the like. Cyclic tertiary hydrocarbyl groups can be illustrated by Formula B:

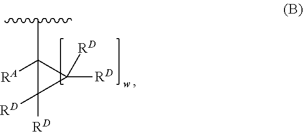

wherein R^{A} is a hydrocarbyl group or substituted hydrocarbyl group, each R^{D} is independently hydrogen or a hydrocarbyl group or substituted hydrocarbyl group, w is an integer from 1 to about 30, and R^{A}, and one or more R^{D}, and or two or more R^{D} may optionally be bonded to one another to form additional rings.

When a cyclic tertiary hydrocarbyl group contains more than one alicyclic ring, it can be referred to as polycyclic tertiary hydrocarbyl group or if the hydrocarbyl group is an alkyl group, it may be referred to as a polycyclic tertiary alkyl group.

The terms “alkyl radical” and “alkyl” are used interchangeably throughout this disclosure. For purposes of this disclosure, “alkyl radical” is defined to be C₁—-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, MAO is methylalumoxane, Bn is benzyl (i.e., CH₂Ph), THE (also referred to as thf) is tetrahydrofuran, RT is room temperature (and is 23° C. unless otherwise indicated), tol is toluene, Cp is cyclopentadienyl, NMR is nuclear magnetic resonance, and TMA is trimethylaluminum.

A “catalyst system” is a combination of at least one catalyst compound, an activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators (including support-bound activators) represented by formulae herein embrace both neutral and ionic forms of the catalyst compounds and activators.

In the description herein, the catalyst may be described as a catalyst, a catalyst precursor, a pre-catalyst compound, a catalyst compound, a metal compound, a transition or lanthanide metal, or a transition or lanthanide metal compound, and these terms are used interchangeably.

An “anionic ligand” is a negatively charged ligand which donates one or more pairs of electrons to a metal ion. The term “anionic donor” is used interchangeably with “anionic ligand”. Examples of anionic donors may include, but are not limited to, methyl, chloride, fluoride, alkoxide, aryloxide, alkyl, alkenyl, thiolate, carboxylate, amido, benzyl, hydrido, amidinate, amidate, and phenyl. Two anionic donors may be joined to form a dianionic group.

A “neutral Lewis base” or “neutral donor group” is an uncharged (neutral) group which donates one or more pairs of electrons to a metal ion. Non-limiting examples of neutral Lewis bases include ethers, thioethers, amines, phosphines, diethyl ether, tetrahydrofuran, dimethylsulfide, triethylamine, pyridine, alkenes, alkynes, allenes, and carbenes. Lewis bases may be joined together to form bidentate or tridentate Lewis bases.

For purposes of the present disclosure and the claims thereto, phenolate donors can include Ph-O—, Ph-S—, and Ph-N(R**)— groups, where R** is hydrogen, C₁-C₄₀ hydrocarbyl, C₁-C₄₀ substituted hydrocarbyl, a heteroatom or a heteroatom-containing group, and Ph is optionally substituted phenyl.

Lanthanide metals (La—Lu), include La, Ce, Pr, Nd, Pm, Sm, Eu, Gd, Tb, Dy, Ho, Er, Tm, Yb, and Lu.

### Catalysts

Catalysts of the present disclosure can be “post-metallocene” catalysts having an oxygen and/or nitrogen atom(s). For example, a catalyst of the present disclosure can be a metal complex having: a metal selected from group 3 or lanthanide metals, and a tridentate, dianionic ligand containing two anionic donor groups and a neutral Lewis base donor, where the neutral Lewis base donor is covalently bonded between the two anionic donors, and where the metal-ligand complex features a pair of 8-membered metallocycle rings.

The catalyst complexes of the present disclosure include a metal selected from group 3 or lanthanide metals of the Periodic Table of the Elements, a tridentate dianionic ligand containing two anionic donor groups and a neutral heterocyclic Lewis base donor, wherein the heterocyclic donor is covalently bonded between the two anionic donors. In some embodiments, the dianionic, tridentate ligand features a central heterocyclic donor group and two phenolate donors and the tridentate ligand coordinates to the metal center to form two eight-membered rings.

In some embodiments, the heterocyclic Lewis base donor of the catalyst compound features a nitrogen or oxygen donor atom. For example, heterocyclic groups include derivatives of pyridine, pyrazine, pyrimidine, triazine, thiazole, imidazole, thiophene, oxazole, thiazole, furan, and substituted variants of thereof. In some embodiments, the heterocyclic Lewis base lacks hydrogen(s) in the position alpha to the donor atom. In some embodiments, a heterocyclic Lewis base donor includes pyridine, 3-substituted pyridines, and 4-substituted pyridines.

The anionic donors of the tridentate dianionic ligand may be arylthiolates, phenolates, or anilides. In some embodiments, anionic donors are phenolates. The tridentate dianionic ligand coordinates to the metal center to form a complex that may lack a mirror plane of symmetry. In some embodiments, the tridentate dianionic ligand coordinates to the metal center to form a complex that has a two-fold rotation axis of symmetry; when determining the symmetry of the bis(phenolate) complexes only the metal and dianionic tridentate ligand are considered (i.e. ignore remaining ligands).

Catalyst compounds of the present disclosure can be bis(aryl phenolate)pyridine complexes. Bis(aryl phenolate)pyridine complexes may have a tridentate bis(aryl phenolate)pyridine ligand that is coordinated to a group 3 transition or lanthanide metal with the formation of two eight-membered rings. In some embodiments, a bis(aryl phenolate)pyridine complexes includes transition or lanthanide metal complexes of a dianionic, tridentate ligand that features a central neutral donor group and two phenolate donors, where the tridentate ligands coordinate to the metal center to form two eight-membered rings, for example, the post-metallocene catalyst can be an 8-8 catalyst. In complexes of this type, it is advantageous for the central neutral donor to be a heterocyclic group. It is advantageous for the heterocyclic group to lack hydrogens in the position alpha to the heteroatom.

In some embodiments, bis(phenolate) ligands can be tridentate dianionic ligands that coordinate to the metal M in such a fashion that a pair of 8-membered metallocycle rings are formed. The bis(phenolate) ligands wrap around the metal to form a complex with a 2-fold rotation axis, thus giving the complexes C₂ symmetry. The C₂ geometry and the 8-membered metallocycle rings are features of these complexes that make them effective catalyst components for the production of polyolefins.

Bis(phenolate), anilide, and/or arylthiolate ligands that contain donor groups (e.g., oxygen, nitrogen, or sulfur, respectively) can be substituted with alkyl, substituted alkyl, aryl, or other groups. It can be advantageous that each phenolate group be substituted in the ring position that is adjacent to the donor atom on the ring structure. For example, that substitution at the position adjacent to the donor atom can be an alkyl group containing 1-20 carbon atoms. In complexes of this type it may also be advantageous for the phenolates to be substituted with one or more alkyl substituents (e.g., ortho and/or para to the oxygen of the phenolate). In some embodiments, a substitution at the position next to the donor atom can be a non-aromatic cyclic alkyl group with one or more five- or six-membered rings. In complexes of this type it may also be advantageous for the phenolates to be substituted with one or more cyclic tertiary alkyl substituents. The use of cyclic tertiary alkyl substituted phenolates can improve the ability of these catalysts to produce high molecular weight polymer. In some embodiments, substitution at the position next to the oxygen donor atom is adamantan-1-yl or substituted adamantan-1-yl.

The neutral heterocyclic Lewis base donor is covalently bonded between the two anionic donors (e.g., between two phenolate groups) via “linker groups” that join the heterocyclic Lewis base to the anionic donors. For example, “linker groups” are indicated by (A³A²) and (A^{2′}A^{3′}) in Formula (I), described in more detail below. The choice of each linker group may affect the catalyst performance. Each linker group can be a C₂-C₄₀ divalent group that is two-atoms in length. One or both linker groups may independently be phenylene, substituted phenylene, heteroaryl, vinylene, or a non-cyclic two-carbon long linker group. In some embodiments, one or both phenylenes may be unsubstituted or may be independently substituted with C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments, a catalyst compound is represented by Formula (I):

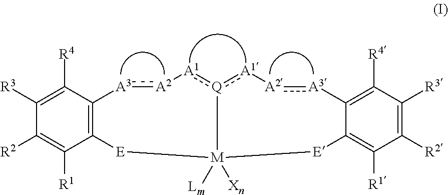

wherein
   M is a group 3 transition metal or a lanthanide metal (such as Sc, Y, La, Lu, or Nd);
   E and E′ are each independently O, S, or NR^{A}, where R^{A} is independently hydrogen, C₁-C₄₀ hydrocarbyl, substituted C₁-C₄₀ hydrocarbyl, or a heteroatom-containing group, such as O, such as both E and E′ are 0;
   Q is group 14, 15, or 16 atom, such as Q is C, O, S, or N, such as Q is C, N, or O, such as Q is N;
   A¹QA^{1′} are part of a heterocyclic Lewis base containing 4 to 40 non-hydrogen atoms that links A² to A^{2′} via a 3-atom bridge with Q being the central atom of the 3-atom bridge (A¹QA^{1′} combined with the curved line shown joining A¹ and A^{1′} represents the heterocyclic Lewis base);
   each of A¹ and A^{1′} is independently C, N, or C(R^{B}), where R^{B} is selected from hydrogen, C₁-C₂₀ hydrocarbyl, and substituted C₁-C₂₀ hydrocarbyl (for example, each of A¹ and A^{1′} are C);

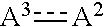

is a divalent group containing 2 to 40 non-hydrogen atoms that links A¹ to the E-bonded aryl group via a 2-atom bridge, and A³ and A² are combined to form a substituted hydrocarbyl ring, an unsubstituted hydrocarbyl ring, a substituted heterocyclic ring, or an unsubstituted heterocyclic rings each having 5, 6, 7, or 8 ring atoms, and where substitutions on the ring can join to form additional rings, such as A³ and A² are combined to form ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene;

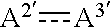

is a divalent group containing 2 to 40 non-hydrogen atoms that links A^{1′} to the E′-bonded aryl group via a 2-atom bridge, and A^{3′} and A^{2′} are combined to form a substituted hydrocarbyl ring, an unsubstituted hydrocarbyl ring, a substituted heterocyclic ring, or an unsubstituted heterocyclic rings each having 5, 6, 7, or 8 ring atoms, and where substitutions on the ring can join to form additional rings, such as A^{3′} and A^{2′} are combined to form, such as ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene;
each L is independently a Lewis base;
X is an anionic ligand;
any two or more L groups may be joined together to form a polydentate (e.g., bidentate) Lewis base;
an X group may be joined to an L group to form a monoanionic bidentate group;
n is 1;
m is 0, 1, or 2;
n+m is not greater than 3; and
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group (such as R^{1′} and R¹ are independently a hydrocarbyl group, such as a tertiary alkyl group, or a cyclic hydrocarbyl group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

The metal, M, is selected from group 3 elements or lanthanide elements. For example, the metal, M, is Sc, Y, La, Lu, or Nd.

The donor atom Q of the neutral heterocyclic Lewis base (in Formula (I)) can be nitrogen sulfur, or oxygen. In some embodiments, Q is nitrogen.

Non-limiting examples of neutral heterocyclic Lewis base groups include pyridine, pyrazine, pyrimidine, triazine, thiazole, imidazole, thiophene, oxazole, thiazole, furan, and substituted variants of thereof. In some embodiments, heterocyclic Lewis base groups can include pyridine, pyrazine, thiazole, or imidazole and substituted variants of thereof.

In some embodiments, each of A¹ and A^{1′} is independently C, N, or C(R²²), where R²² is selected from hydrogen, C₁-C₂₀ hydrocarbyl, and substituted C₁-C₂₀ hydrocarbyl. In some embodiments, each of A¹ and A^{1′} is carbon. When Q is carbon, each of A¹ and A^{1′} can be independently selected from nitrogen and C(R²²). When Q is nitrogen, each of A¹ and A^{1′} can be carbon. In some embodiments, Q=nitrogen and A¹=A^{1′}=carbon. When Q is nitrogen or oxygen, the heterocyclic Lewis base of Formula (I) might not have any hydrogen atoms bound to the A¹ or A^{1′} atoms, which may be preferred because it is thought that hydrogens in those positions may undergo unwanted decomposition reactions that reduce the stability of the catalytically active species.

In at least one embodiment of Formula (I), Q is carbon and each of A¹ and A^{1′} is N or C(R²²), where R²² is selected from hydrogen, C₁-C₂₀ hydrocarbyl, substituted C₁-C₂₀ hydrocarbyl, a heteroatom or a heteroatom-containing group. In such embodiments, the A¹QA^{1′} fragment forms part of a cyclic carbene, N-heterocyclic carbene, cyclic amino alkyl carbene, or a substituted variant thereof.

The heterocyclic Lewis base (of Formula (I)) represented by A¹QA^{1′} combined with the curved line joining A¹ and A^{1′} can be selected from the following, with each R²³ group selected from hydrogen, heteroatoms, C₁-C₂₀ alkyls, C₁-C₂₀ alkoxides, C₁-C₂₀ amides, and substituted C₁-C₂₀ alkyls.

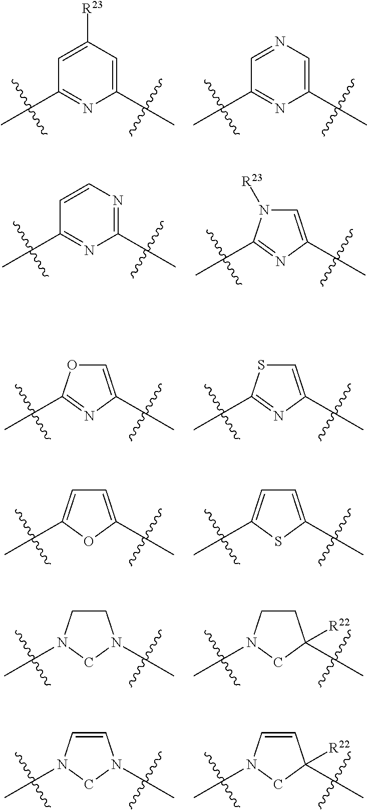

In some embodiments, the heterocyclic Lewis base (of Formula (I)) represented by A¹QA^{1′} combined with the curved line joining A¹ and A^{1′} is a six membered ring containing zero or one ring heteroatoms or a five membered ring containing zero, one two or three ring heteroatoms. Alternately, the heterocyclic Lewis base (of Formula (I)) represented by A¹QA^{1′} combined with the curved line joining A¹ and A^{1′} is not a six membered ring containing two or more ring heteroatoms.

In some embodiments of Formula (I), A¹QA^{1′} are part of a heterocyclic Lewis base containing 2 to 20 non-hydrogen atoms that links A² to A^{2′} via a 3-atom bridge with Q being the central atom of the 3-atom bridge. In some embodiments, each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In some embodiments of Formula (I), M is Sc, Y, La, Lu, or Nd, Q is nitrogen, both A¹ and A^{1′} are carbon, both E and E′ are oxygen, and both R¹ and R^{1′} are independently C₄-C₂₀ hydrocarbyl groups, preferably C₄-C₂₀ tertiary alkyl groups and cyclic tertiary alkyl groups.

In some embodiments of Formula (I), M is Sc, Y, La, Lu, or Nd, Q is nitrogen, both A¹ and A^{1′} are carbon, both E and E′ are oxygen, and both R¹ and R^{1′} are independently adamantan-1-yl or substituted adamantan-1-yl.

In some embodiments of Formula (I), M is Sc, Y, La, Lu, or Nd, Q is nitrogen, both A¹ and A^{1′} are carbon, both E and E′ are oxygen, and both R¹ and R^{1′} are independently acyclic tertiary alkyl, such as tert-butyl, or tert-pentyl.

In some embodiments, a catalyst compound is represented by Formula (II):

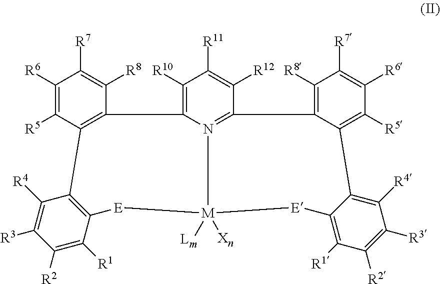

wherein:
   M is a group 3 metal or a lanthanide metal (such as Sc, Y, La, Lu, or Nd);
   E and E′ are each independently O, S, or NR^{A}, where R^{A} is independently hydrogen, C₁-C₄₀ hydrocarbyl, substituted C₁-C₄₀ hydrocarbyl, or a heteroatom-containing group, such as both E and E′ are O;
   each L is independently a Lewis base;
   X an anionic ligand;
   any two or more L groups may be joined together to form a polydentate (e.g., bidentate) Lewis base;
   an X group may be joined to an L group to form a monoanionic bidentate group;
   n is 1;
   m is 0, 1, or 2;
   n+m is not greater than 3;
   each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
   each of R⁵, R⁶, R⁷, R⁸, R^{5′}, R^{6′}, R^{7′}; R^{8′}, R¹⁰, R¹¹, and R¹² is independently hydrogen, C₁-C₄₀ hydrocarbyl, substituted C₁-C₄₀ hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In Formula (II), E and E′ are each independently selected from oxygen or NR^{A}, where R^{A} is independently hydrogen, C₁-C₄₀ hydrocarbyl, substituted C₁-C₄₀ hydrocarbyl, or a heteroatom-containing group. In some embodiments, E and E′ are oxygen. When E and/or E′ are NR^{A}, R^{A} can be selected from C₁ to C₂₀ hydrocarbyls, alkyls, or aryls. In one embodiment, E and E′ are each independently selected from O, S, N(alkyl), or N(aryl), where the alkyl can be a C₁ to C₂₀ alkyl, such as methyl, ethyl, propyl, butyl, pentyl, hexyl, octyl, nonyl, decyl, undecyl, dodecyl, and the like, and aryl is a C₆ to C₄₀ aryl group, such as phenyl, naphthalenyl, benzyl, methylphenyl, and the like.

In some embodiments, a catalyst compound is represented by Formula (III), Formula (IV) or Formula (V):

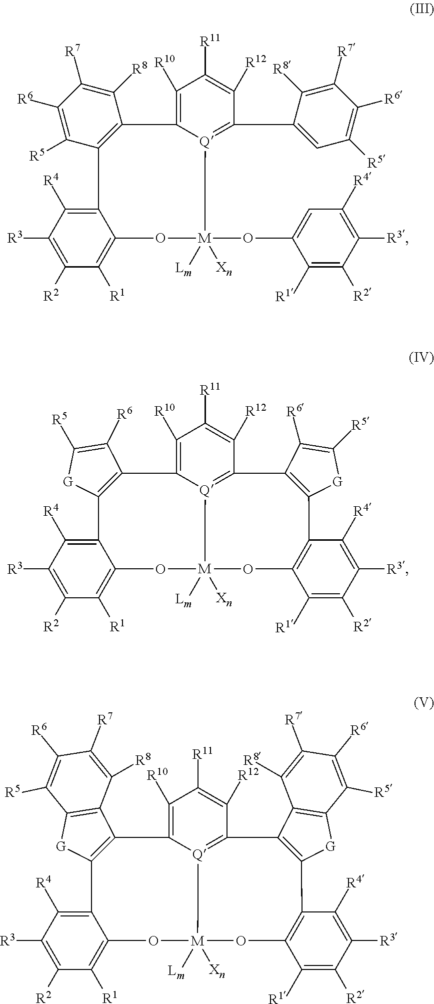

wherein:
   M of Formula (III), Formula (IV) or Formula (V) represents Sc, Y or a La—Lu lanthanide metal;
   Q′ of Formula (III), Formula (IV) or Formula (V) is a group 15 heteroatom, preferably N and P, most preferably N;
   X of Formula (III), Formula (IV) or Formula (V) is an anionic ligand;
   each L of Formula (III), Formula (IV) or Formula (V) is independently a Lewis base;
   any two or more L groups of Formula (III), Formula (IV) or Formula (V) may be joined together to form a polydentate (e.g., bidentate) Lewis base;
   an X group of Formula (III), Formula (IV) or Formula (V) may be joined to an L group to form a monoanionic bidentate group;
   n of Formula (III), Formula (IV) or Formula (V) is 1;
   m of Formula (III), Formula (IV) or Formula (V) is 0, 1, or 2;
   n+m of Formula (III), Formula (IV) or Formula (V) is not greater than 3;
   each of R¹, R², R³, R⁴, R^{1′}, R^{2′}, R^{3′}, and R^{4′} of Formula (III), Formula (IV) or Formula (V) is independently hydrogen, C₁-C₄₀ hydrocarbyl, substituted C₁-C₄₀ hydrocarbyl, a heteroatom or a 5 heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
   each of R⁵, R⁶, R⁷, R⁸, R^{5′}, R^{6′}, R^{7′}; R^{8′}, R¹⁰, R¹¹, and R¹² of Formula (III), Formula (IV) or Formula (V) is independently hydrogen, C₁-C₄₀ hydrocarbyl, substituted C₁-C₄₀ hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
   each G of Formula (III), Formula (IV) or Formula (V) is a group 15 or 16 heteroatom or heteroatom group such as S, O, NR′, PR′ where R′ is selected from hydrogen atoms and C₁-C₄₀ hydrocarbyl or substituted hydrocarbyl groups.

In some embodiments of catalyst compounds of Formulae (I-II), when E and E′ are oxygen, each phenolate group can be substituted in the position that is next to the oxygen atom (i.e. R¹ and R^{1′} in Formula (I-II). Thus, when E and E′ are oxygen, each of R¹ and R^{1′} is independently a C₁-C₄₀ hydrocarbyl, a substituted C₁-C₄₀ hydrocarbyl, a heteroatom, or a heteroatom-containing group, such as each of R¹ and R^{1′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of catalyst compounds of Formulae (III-V), each phenolate group can be substituted in the position that is next to the oxygen atom (i.e. R¹ and R^{1′} in Formula (III-V). Thus, each of R¹ and R^{1′} is independently a C₁-C₄₀ hydrocarbyl, a substituted C₁-C₄₀ hydrocarbyl, a heteroatom, or a heteroatom-containing group, such as each of R¹ and R^{1′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of the catalyst compound of Formulae (I-V), each of R¹ and R^{1′} is independently a tertiary hydrocarbyl group. In other embodiments of Formulae (I-V), each of R¹ and R^{1′} is independently a (substituted or unsubstituted) cyclic tertiary hydrocarbyl group. In other embodiments of the catalyst compound of Formulae (I-V), each of R¹ and R^{1′} is independently a (substituted or unsubstituted) polycyclic tertiary hydrocarbyl group.

In some embodiments of catalyst compounds of Formulae (I-II), when E and E′ are oxygen, each phenolate group can be substituted in the position that is para to the oxygen atom (i.e. R³ and R^{3′} in Formulae (I-II)). Thus, when E and E′ are oxygen, each of R³ and R^{3′} is independently a C₁-C₄₀ hydrocarbyl, a substituted C₁-C₄₀ hydrocarbyl, a heteroatom, or a heteroatom-containing group, such as each of R³ and R^{3′} is independently C₁-C₂₀ alkyl, such as methyl, ethyl, propyl, butyl, pentyl, hexyl, heptyl, octyl, nonyl, decyl, or an isomer thereof. Alternatively, each of R³ and R^{3′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of catalyst compounds of Formulae (III-V), each phenolate group can be substituted in the position that is para to the oxygen atom (i.e., R³ and R^{3′} in Formulae (III-V)). Thus, each of R³ and R^{3′} is independently a C₁-C₄₀ hydrocarbyl, a substituted C₁-C₄₀ hydrocarbyl, a heteroatom, or a heteroatom-containing group, such as each of R³ and R^{3′} is independently C₁-C₂₀ alkyl, such as methyl, ethyl, propyl, butyl, pentyl, hexyl, heptyl, octyl, nonyl, decyl, or an isomer thereof. Alternatively, each of R³ and R^{3′} is independently a non-aromatic cyclic alkyl group with one or more five- or six-membered rings (such as cyclohexyl, cyclooctyl, adamantanyl, or 1-methylcyclohexyl, or substituted adamantanyl), such as a non-aromatic cyclic tertiary alkyl group (such as 1-methylcyclohexyl, adamantanyl, or substituted adamantanyl).

In some embodiments of the catalyst compound of Formulae (I-V), each of R³ and R^{3′} is independently a (substituted or unsubstituted) C₁-C₂₀ alkyl, such as methyl, ethyl, propyl, butyl, pentyl, hexyl, heptyl, octyl, nonyl, decyl, or isomers thereof. In some embodiments of the catalyst compound of Formulae (I-V), each of R³ and R^{3′} is independently a (substituted or unsubstituted) acyclic tertiary hydrocarbyl group. In other embodiments of Formulae (I-V), each of R³ and R^{3′} is independently a tert-butyl.

In some embodiments, one or more of R¹, R², R³, R⁴, R^{1′}, R^{2′}, R^{3′}, R^{4′}, R⁵, R⁶, R⁷, R⁸, R^{5′}, R^{6′}, R^{7′}; R^{8′}, R¹⁰, R¹¹, or R¹² of Formulae (II-V) are independently hydrogen or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments of Formulae (I-V), M is a group 3 metal, such as Sc, Y, La, Lu, or Nd.

In some embodiments of Formulae (I) and (II), each of E and E′ is O.

In some embodiments of Formulae (I-V), each of R¹, R², R³, R⁴, R^{1′}, R^{2′}, R^{3′}, and R^{4′} is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, adamantanyl, and isomers thereof.

In embodiments of Formulae (I-V), X is selected from hydrocarbyl radicals having from 1 to 20 carbon atoms (such as alkyls or aryls), hydrides, amides, alkoxides, sulfides, phosphides, halides, alkyl sulfonates, such as X is selected from halides, aryls, and C₁ to C₅ alkyl groups, such as X is a hydrido, dimethylamido, diethylamido, bis(dimethylsilyl)amido, bis(trimethylsilyl)amido, methylenetrimethylsilyl, neopentyl, phenyl, benzyl, methyl, ethyl, propyl, butyl, pentyl, fluoro, iodo, bromo, or chloro group. In some embodiments, X is selected from bis(dimethylsilyl)amido, bis(trimethylsilyl)amido, and methylenetrimethylsilyl.

Alternatively, X may be a halide, a hydride, an alkyl group, or an alkenyl group.

In some embodiments of Formulae (I-V), each L is a Lewis base, independently, selected from ethers, thio-ethers, amines, nitriles, imines, pyridines, halocarbons, and phosphines, such as ethers, thioethers, or a combination thereof, optionally two or more L's may form a part of a fused ring or a ring system, such as each L is independently selected from ether or thioether groups, such as each L is an ethyl ether, tetrahydrofuran, dibutyl ether, or dimethylsulfide group.

In some embodiments of Formulae (I-V), each of R¹ and R^{1′} is independently cyclic tertiary alkyl groups.

In some embodiments of Formulae (I-V), m is 0, 1 or 2, such as 0.

In some embodiments of Formulae (I-V), each of R¹ and R^{1′} is not hydrogen.

In some embodiments of Formulae (I-V), each of R³ and R^{3′} is not hydrogen.

In some embodiments of Formulae (I) and (II), M is Sc, Y, La, Lu, or Nd, each of E and E′ is O; each of R¹ and R^{1′} is independently a C₁-C₄₀ hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, or substituted C₁-C₂₀ hydrocarbyl.

In some embodiments of Formulae (III-V), M is Sc, Y, La, Lu, or Nd, each of R¹ and R^{1′} is independently a C₁-C₄₀ hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, or substituted C₁-C₂₀ hydrocarbyl.

In some embodiments of Formulae (II-V), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In some embodiments of Formulae (II-V), each of R⁵, R⁶, R⁷, R⁸, R^{′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, or isomers thereof.

In some embodiments of Formula (II), M is Sc, Y, La, Lu, or Nd, each of E and E′ is O; each of R¹ and R^{1′} is independently a C₁-C₄₀ hydrocarbyl, a substituted C₁-C₄₀ hydrocarbyl, a heteroatom or a heteroatom-containing group; each of R³ and R^{3′} is independently a C₁-C₄₀ hydrocarbyl, a substituted C₁-C₄₀ hydrocarbyl, a heteroatom or a heteroatom-containing group; each of R¹, R², R⁴, R^{1′}, R^{2′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; X is selected from the group consisting of substituted or unsubstituted: hydrocarbyl radicals having from 1 to 20 carbon atoms (such as alkyls or aryls), hydrides, amides, alkoxides, sulfides, phosphides, halides, dienes, amines, phosphines, ethers; n is 1; m is 1; and each of R⁵, R⁶, R⁷, R⁸, R^{1′}, R^{6′}, R^{7′}, R^{8′}, R¹⁰, R¹¹ and R¹² is independently hydrogen, C₁-C₂₀ hydrocarbyl, substituted C₁-C₂₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formulae (IV-V), Q′ is N.

In some embodiments of Formulae (III-V), M is Sc, Y, La, Lu, or Nd; each of R¹ and R^{1′} is independently a C₁-C₄₀ hydrocarbyl, a substituted C₁-C₄₀ hydrocarbyl, a heteroatom or a heteroatom-containing group; each of R³ and R^{3′} is independently a C₁-C₄₀ hydrocarbyl, a substituted C₁-C₄₀ hydrocarbyl, a heteroatom or a heteroatom-containing group; each of R¹, R², R⁴, R^{1′}, R^{2′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; X is selected from the group consisting of substituted or unsubstituted: hydrocarbyl radicals having from 1 to 20 carbon atoms (such as alkyls or aryls), hydrides, amides, alkoxides, sulfides, phosphides, halides, dienes, amines, phosphines, ethers; n is 1; m is 1; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, substituted C₁-C₂₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formula (II), M is Sc, Y, La, Lu, or Nd, both E and E′ are oxygen, both R¹ and R^{1′} are independently C₄-C₂₀ cyclic tertiary alkyl, and both R³ and R^{3′} are independently C₁-C₁₀ alkyl.

In some embodiments of Formulae (III-V), M is Sc, Y, La, Lu, or Nd; both R¹ and R^{1′} are independently C₄-C₂₀ cyclic tertiary alkyl, and both R³ and R^{3′} are independently C₁-C₁₀ alkyl.

In some embodiments of Formula (II), M is Sc, Y, La, Lu, or Nd, both E and E′ are oxygen, both R¹ and R^{1′} are adamantan-1-yl or substituted adamantan-1-yl, and both R³ and R^{3′} are independently C₁-C₁₀ alkyl.

In some embodiments of Formulae (III-V), M is Sc, Y, La, Lu, or Nd; both R¹ and R^{1′} are adamantan-1-yl or substituted adamantan-1-yl, and both R³ and R^{3′} are independently C₁-C₁₀ alkyl.

In some embodiments of Formula (II), M is Sc, Y, La, Lu, or Nd, both E and E′ are oxygen, and each of R¹, R^{1′} are independently adamantan-1-yl or substituted adamantan-1-yl and both R³ and R^{3′} are independently methyl or tert-butyl.

In some embodiments of Formulae (III-V), M is Sc, Y, La, Lu, or Nd; each of R¹, R^{1′} are independently adamantan-1-yl or substituted adamantan-1-yl and both R³ and R^{3′} are independently methyl or tert-butyl.

In some embodiments of Formulae (IV-V), G is S, O, NR′, PR′ where R′ is selected from hydrogen and hydrocarbyl or substituted hydrocarbyl groups.

In some embodiments of Formulae (IV-V), G is S or O, more preferably S.

In some embodiments of Formulae (IV-V), G is NR′, PR′ where R′ is selected from hydrogen atoms and C₁-C₂₀ hydrocarbyls and substituted hydrocarbyls.

In some embodiments of Formulae (IV-V), G is NR′, PR′ and R′ is selected from hydrogen or methyl.

In some embodiments of Formula (III), M is Sc, Y, La, Lu, or Nd; each of R¹, R^{1′} are adamantan-1-yl or substituted adamantan-1-yl, both R³ and R^{3′} are tert-butyl or methyl, and R², R^{2′}, R⁴, R^{4′}, R⁵, R^{5′}, R⁶, R^{6′}, R⁷, R^{7′}, R⁸, R^{8′}, R¹⁰, R¹¹ and R¹² are hydrogen.

In some embodiments of Formula (III), M is Sc, Y, La, Lu, or Nd; each of R¹, R^{1′} are tert-butyl, both R³ and R^{3′} are tert-butyl or methyl, and R², R^{2′}, R⁴, R^{4′}, R⁵, R^{5′}, R⁶, R^{6′}, R⁷, R^{7′}. R⁸, R^{8′}, R¹⁰, R¹¹ and R¹² are hydrogen.

In some embodiments of Formula (V), M is Sc, Y, La, Lu, or Nd; G is S, both of R¹, R^{1′} are tert-butyl, both R³ and R^{3′} are methyl, and R², R^{2′}, R⁴, R^{4′}, R⁵, R^{5′}, R⁶, R^{6′}, R⁷, R^{7′}. R⁸, R^{8′}, R¹⁰, R¹¹ and R¹² are hydrogen.

In some embodiments of Formula (V), M is Sc, Y, La, Lu, or Nd; G is S, both of R¹, R^{1′} are adamantan-1-yl or substituted adamantan-1-yl, both R³ and R^{3′} are methyl or tert-butyl, and R², R^{2′}, R⁴, R^{4′}, R⁵, R^{5′}, R⁶, R^{6′}, R⁷, R^{7′}. R⁸, R^{8′}, R¹⁰, R¹¹ and R¹² are hydrogen.

### Activators

The terms “cocatalyst” and “activator” are used herein interchangeably.

The catalyst systems described herein may include catalyst compound(s) as described above and an activator such as alumoxane or a non-coordinating anion and may be formed by combining the catalyst compounds described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, a-bound, metal ligand making the metal compound cationic and providing a charge-balancing non-coordinating or weakly coordinating anion, e.g., a non-coordinating anion.

In at least one embodiment, the catalyst system includes an activator, and a catalyst compound of Formulae (I-V), or combinations thereof.

### Alumoxane Activators

Alumoxane activators are utilized as activators in the catalyst systems described herein. Alumoxanes are generally oligomeric compounds containing—Al(R^{a′″})—O— sub-units, where R^{a′″} is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, as described in U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), and in at least one embodiment, an amount of activator at up to a 5,000-fold molar excess Al/M over the catalyst compound (per metal catalytic site) may be used. The minimum activator-to-catalyst-compound may be a 1:1 molar ratio. Alternate ranges may include about 1:1 to about 500:1, alternately about 1:1 to about 200:1, alternately about 1:1 to about 100:1, or alternately about 1:1 to about 50:1.

In an alternate embodiment, little or no alumoxane is used in the polymerization processes described herein. For example, alumoxane can be present at zero mol %, alternately the alumoxane can be present at a molar ratio of aluminum to catalyst compound metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral metal compound and a neutral by-product from the anion. Non-coordinating anions useful in accordance with the present disclosure are those that are compatible, stabilize the metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators.

For descriptions of some suitable activators please see U.S. Pat. Nos. 8,658,556 and 6,211,105, incorporated by reference herein. Additional suitable activators are described in US Patent Publication 2021/0179650, incorporated by reference herein.

In some embodiments, an activator can be one or more of N,N-dimethylanilinium tetrakis(perfluorophenyl)borate, N,N-dimethylanilinium tetrakis(perfluoronaphthyl)borate, dioctadecylmethylammonium tetrakis(perfluorophenyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

In at least one embodiment, the activator is selected from one or more of a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, or triphenylcarbenium tetrakis(3,5-bis(trifluoromethyl)phenyl)borate).

Suitable activator-to-catalyst ratio, e.g., all NCA activators-to-catalyst ratio may be about a 1:1 molar ratio. Alternate ranges include about 0.1:1 to about 100:1, alternately about 0.5:1 to about 200:1, alternately about 1:1 to about 500:1, alternately about 1:1 to about 1000:1. Suitable ranges can be about 0.5:1 to about 10:1, such as about 1:1 to about 5:1.

It is also within the scope of the present disclosure that the catalyst compounds can be combined with combinations of alumoxanes and NCA's (see for example, U.S. Pat. Nos. 5,153,157; 5,453,410; 5,817,725; WO1994/007928; and WO1995/014044, incorporated herein by reference, which discuss the use of an alumoxane in combination with an ionizing activator).

Chain transfer agents may be used in polymerization processes of the present disclosure. Useful chain transfer agents can be hydrogen, alkylalumoxanes, a compound represented by the formula AlR₃, ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof. For some catalysts, in particular Sc based catalysts of Formulae (I) to (V), the chain transfer agent can be used to control the molecular weight of the polymer produced. Preferred chain transfer agents for polymer molecular weight control include tri-n-butyl aluminum, tri-n-hexyl aluminum, tri-n-octyl aluminum, tri-isobutyl aluminum, and diisobutyl aluminum hydride. Chain transfer agents for polymer molecular weight control can include tri-n-octyl aluminum and tri-isobutyl aluminum. In some embodiments, the chain transfer agent is used at a chain transfer agent to catalyst molar ratio of 1:1 to 1,000:1, alternatively 1:1 to 1:500, alternatively 1:1 to 1:100, alternatively 1:1 to 1:50, alternatively 1:1 to 1:25.

Furthermore, a catalyst system of the present disclosure may include a metal hydrocarbenyl chain transfer agent represented by the formula:

Al(R′)₃₋ᵥ(R″)ᵥ
where each R′ can be independently a C₁-C₃₀ hydrocarbyl group, and or each R″, can be independently a C₄-C₂₀ hydrocarbenyl group having an end-vinyl group; and v can be from 0.1 to 3.

### Support Materials

In embodiments herein, the catalyst system may include an inert support material. The support material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 m to about 500 m. The surface area of the support material can be of about 50 m²/g to about 500 m²/g, pore volume of about 0.5 cm³/g to about 3.5 cm³/g and average particle size of about 10 m to about 200 m. For example, the surface area of the support material can be about 100 m²/g to about 400 m²/g, pore volume of about 0.8 cm³/g to about 3.0 cm³/g and average particle size can be about 5 μm to about 100 μm. The average pore size of the support material useful in the present disclosure can be of about 10 Å to about 1000 Å, such as about 50 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W. R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free or substantially free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar diluent and the resulting slurry is contacted with a solution of a catalyst compound and an activator. In at least one embodiment, the slurry of the support material is first contacted with the activator for a period of time of about 0.5 hour to about 24 hours, about 2 hours to about 16 hours, or about 4 hours to about 8 hours. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 hour to about 24 hours, about 2 hours to about 16 hours, or about 4 hours to about 8 hours. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar diluents are materials in which all of the reactants used herein, e.g., the activator and the catalyst compound, are at least partially soluble and which are liquid at polymerization temperatures. Non-polar diluents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polymerization Processes

The present disclosure relates to polymerization processes where monomer (e.g., ethylene; propylene), and optionally comonomer, are contacted with a catalyst system including an activator and at least one catalyst compound, as described above. The catalyst compound and activator may be combined in any suitable order. The catalyst compound and activator may be combined prior to contacting with the monomer. Alternatively, the catalyst compound and activator may be introduced into the polymerization reactor separately, wherein they subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes ethylene and an optional comonomer including one or more C₃ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Comonomers may include substituted or unsubstituted C₄ to C₃₀ conjugated dienes, such as C₄ to C₂₀ conjugated dienes, such as C₄ to C₆ conjugated dienes, such as 1,3-butadiene, 2-methyl-1,3-butadiene, 1,3-pentadiene, 1,3-hexadiene, 2,4-hexadiene, 1,3-heptadiene, 1,3-octadiene, 1,3-nonadiene, 1,3-decadiene, cyclopentadiene. In at least one embodiment, the monomer includes ethylene and an optional comonomer including one or more C₄ to C₃₀ conjugated dienes, such as C₄ to C₂₀ conjugated dienes, such as C₄ to C₆ conjugated dienes. The C₄ to C₃₀ conjugated dienes may be linear, branched, or cyclic. The C₄ to C₃₀ cyclic conjugated dienes may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Exemplary C₄ to C₃₀ conjugated dienes comonomers may include 1,3-butadiene, 2-methyl-1,3-butadiene, 1,3-pentadiene, 1,3-hexadiene, 2,4-hexadiene, 1,3-heptadiene, 1,3-octadiene, 1,3-nonadiene, 1,3-decadiene, cyclopentadiene, methylcyclopentadiene.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be used. A bulk homogeneous process can be used. Alternately, no solvent or diluent is present or added in the reaction medium, (except for the small amounts used as the carrier for the catalyst system or other additives, or amounts found with the monomer, e.g., propane in propylene). In another embodiment, the process is a slurry process. As used herein, the term “slurry polymerization process” means a polymerization process where a supported catalyst is employed, and monomers are polymerized on the supported catalyst particles. At least 95 wt % of polymer products derived from the supported catalyst are in granular form as solid particles (not dissolved in the diluent).

Polymerizations of the present disclosure can include copolymerization of butadiene and ethylene. In general, the copolymerization of ethylene with butadiene on an industrial scale is considered a difficult process, as the reaction mechanism of polymerization and relative reactivities of the monomers is believed to differ. The polymerization processes described herein has been found to reduce the manufacture and processing issues associated with such polymers—the processes being shown to produce high molecular weight polymer with increased catalyst activity.

In some embodiments, polymerization processes are conducted through contacting the monomer composition, that includes ethylene and one or more conjugated dienes, with a catalyst system having one or more catalyst compounds and an activator, as described above. The catalyst compound and activator may be combined in any order, and are combined typically prior to contacting with the monomer.

Example conjugated diene monomers can include any hydrocarbon structure, such as C₄ to C₃₀, having at least two unsaturated bonds that are adjacent to each other. Examples of conjugated dienes include isoprene, 1,3-butadiene, 1,3-pentadiene, 1,3-hexadiene, 1,3-heptadiene, 1,3-octadiene, 1,3-nonadiene, 1,3-decadiene, cyclopentadiene, dicyclopentadiene or higher ring containing diolefins with or without substituents at various ring positions.

Polymerization processes can be carried out in any suitable manner known in the art. Any suspension, homogeneous, bulk, solution, slurry, or gas phase polymerization process can be used. Such processes can be run in a batch, semi-batch, or continuous mode. Homogeneous polymerization processes and slurry processes can be employed. (A homogeneous polymerization process is defined to be a process where at least 90 wt % of the product is soluble in the reaction media.) A homogeneous process can be a bulk homogeneous process. (A bulk process is defined to be a process where monomer concentration in all feeds to the reactor is 70 vol % or more.) Alternately, no solvent or diluent is present or added in the reaction medium, (except for the small amounts used as the carrier for the catalyst system or other additives, or amounts typically found with the monomer). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In some embodiments, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, such as less than 0.5 wt %, such as less than 0 wt % based upon the weight of the solvents.

In at least one embodiment, a feedstream to the reactor has a feed concentration of the monomers and comonomers for the polymerization is 60 vol % diluent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures and or pressures include a temperature of about 0° C. to about 300° C., such as about 20° C. to about 200° C., such as about 35° C. to about 160° C., such as about 80° C. to about 160° C., such as about 85° C. to about 140° C. Polymerizations can be run at a pressure of about 0.1 MPa to about 25 MPa, such as about 0.45 MPa to about 6 MPa, or about 0.5 MPa to about 4 MPa.

In a suitable polymerization, the run time of the reaction can be up to about 1,500 minutes, such as about 1,200 minutes, such as about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 180 minutes. In a continuous process the run time may be the average residence time of the reactor.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, alumoxane can be present at zero mol %, alternately the alumoxane can be present at a molar ratio of aluminum to transition or lanthanide metal less than 500:1, such as less than 300:1, such as less than 100:1, such as less than 1:1.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted in an aliphatic hydrocarbon diluent (such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof; such as where aromatics are present in the diluent at less than 1 wt %, such as less than 0.5 wt %, such as at 0 wt % based upon the weight of the diluents); 4) wherein the catalyst system used in the polymerization comprises less than 0.5 mol %, such as about 0 mol % alumoxane, alternately the alumoxane is present at a molar ratio of aluminum to transition or lanthanide metal less than 500:1, such as less than 300:1, such as less than 100:1, such as less than 1:1; 5) the polymerization occurs in one reaction zone; 6) optionally scavengers (such as trialkyl aluminum compounds) are absent (e.g., present at zero mol %, alternately the scavenger is present at a molar ratio of scavenger metal to transition or lanthanide metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes no more than one catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone. Room temperature is 23° C. unless otherwise noted.

Other additives may also be used in the polymerization, as desired, such as one or more scavengers, hydrogen, aluminum alkyls, or chain transfer agents such as alkylalumoxanes, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

In some embodiments, the polymerization process is a solution phase polymerization process. A solution polymerization is a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are not turbid as described in Oliveira, J. V. et al. (2000) Ind. Eng, Chem. Res. v. 29, pg. 4627. Solution polymerization may involve polymerization in a continuous reactor in which the polymer formed, the starting monomer and catalyst materials supplied are agitated to reduce or avoid concentration gradients and in which the monomer acts as a diluent or solvent or in which a hydrocarbon is used as a diluent or solvent. Suitable processes can operate at temperatures from about 0° C. to about 250° C., such as from about 50° C. to about 170° C., such as from about 80° C. to about 150° C., and or at pressures of about 0.1 MPa or more, such as 0.5 MPa or more. The upper pressure limit is not critically constrained but can be about 200 MPa or less, such as 120 MPa or less, such as 30 MPa or less. Temperature control in the reactor can be obtained by balancing the heat of polymerization and with reactor cooling by reactor jackets or cooling coils to cool the contents of the reactor, auto refrigeration, pre-chilled feeds, vaporization of liquid medium (diluent, monomers or solvent) or combinations of all three. Adiabatic reactors with pre-chilled feeds can also be used. The purity, type, and amount of solvent can be optimized for the maximum catalyst productivity for a particular type of polymerization. The solvent can be also introduced as a catalyst carrier. The solvent can be introduced as a gas phase or as a liquid phase depending on the pressure and temperature. Advantageously, the solvent can be kept in the liquid phase and introduced as a liquid. Solvent can be introduced in the feed to the polymerization reactors.

A process described herein can be a solution polymerization process that may be performed in a batchwise fashion (e.g., batch; semi-batch) or in a continuous process. Suitable reactors may include tank, loop, and tube designs. In at least one embodiment, the process is performed in a continuous fashion and dual loop reactors in a series configuration are used. In at least one embodiment, the process is performed in a continuous fashion and dual continuous stirred-tank reactors (CSTRs) in a series configuration are used. Furthermore, the process can be performed in a continuous fashion and a tube reactor can be used. In another embodiment, the process is performed in a continuous fashion and one loop reactor and one CSTR are used in a series configuration. The process can also be performed in a batchwise fashion and a single stirred tank reactor can be used.

### Catalyst Activity and Polymer Properties

Unless otherwise indicated, catalyst activity is a measure of how active the catalyst is and is reported as the mass of product polymer (P) produced per mole of catalyst (cat) used (kgP/molcat), or as the mass of product polymer (P) produced per mass of catalyst (cat) used (gP/gcat). The amount (mole or mass) of catalyst refers to the amount (mole or mass) of metal element of the catalyst. Catalyst activity may also be expressed over a period of time T of hours and reported as the mass of product polymer (P) produced per mole or millimole of catalyst (cat) used and expressed in units of gPmmolcat⁻¹hr⁻¹. The activity of the catalyst utilized in the copolymerization of ethylene and conjugated dienes is dependent on the structure of the catalyst, the activator used, the metal element incorporated within the catalyst, the concentration of the catalyst within the reaction media, and/or the composition of the monomer system being copolymerized. In some embodiments, the catalyst activator is either N,N-dimethylanilinium tetrakis(perfluorophenyl)borate (“DIMAH-D4”) or MAO. In some embodiments, the co-activator is diisobutylaluminum hydride (DIBAL). In some embodiments, the catalyst activity is about 0.01 kg_{polymer}/mol_{cat} to about 1000 kg_{polymer}/mol_{cat}, such as about 10 kg_{polymer}/mol_{cat} to about 490 kg_{polymer}/mol_{cat} such as about 25 kg_{polymer}/mol_{cat} to about 480 kg_{polymer}/mol_{cat} such as about 100 kg_{polymer}/mol_{cat} to about 470 kg_{polymer}/mol_{cat}. In some embodiments, the catalyst activity is about 0.01 kg_{polymer}/mol_{cat} to about 15 kg_{polymer}/mol_{cat}. In some embodiments, the catalyst activity is about 25 kg_{polymer}/molLN to about 50 kg_{polymer}/mol_{cat}. In some embodiments, the catalyst activity is about 100 kg_{polymer}/mol_{cat} to about 300 kg_{polymer}/mol_{cat}, such as about 200 kg_{polymer}/mol_{cat} to about 285 kg_{polymer}/mol_{cat}. In some embodiments, the catalyst activity is about 400 kg_{polymer}/mol_{cat} to about 500 kg_{polymer}/mol_{cat}, such as about 450 kg_{polymer}/mol_{cat} to about 465 kg_{polymer}/mol_{cat}. Most notably, the catalyst systems disclosed herein have increased catalyst activity than that previously reported for ethylene-butadiene copolymerization(s) (e.g. >405 kg_{polymer}/mol_{cat}) (Macromolecules 2021, v. 54, pg. 9445).

In some embodiments, the polyolefin product produced are formed via the copolymerization of ethylene and conjugated diene. In general, the copolymerization of ethylene with conjugated diene on an industrial scale is considered a difficult process, as the polymerization mechanism and relative reactivities of the monomers differ from each other. The polymerization processes described herein have been found to reduce the manufacture and processing issues associated with such polymers—the process being shown to produce high molecular weight polymer with increased catalyst activity.

In some embodiments, the copolymer formed from the copolymerization between ethylene and butadiene is represented by:

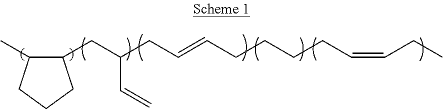

Notable aspects of the copolymer include butadiene units with two adjacent carbon atoms of a cyclopentane ring in the backbone. Some of the butadiene incorporates in the trans 1,4 configuration forming a straight backbone with one unsaturation. Some of the butadiene may also incorporate into the copolymer in the cis 1,4 configuration also forming a straight backbone with one unsaturation but having both of the hydrogens associated with the double bond carbons on the same side of the double bond. Finally, some of the butadiene, usually a very small to nil portion, may incorporate in the 1,2 configuration leaving a pendant vinyl group as an unsaturated branch on the saturated carbon chain. Therefore the copolymer can be formed with a sufficient amount of residual unsaturation in the backbone or in side chains for eventual use in special applications such as crosslinking or chemical modification.

The ethylene copolymers of the current disclosure have improved properties resulting especially from the more efficient use of diene comonomer in controlling the crystallizability of the polymer. That is, the efficient use of the diene comonomer comprises an improved isolation of the comonomer molecules along the polyethylene chains as not previously achieved for such ethylene copolymers. Accordingly, the polymers of the present disclosure not only have especially good application for those uses previously employing such polymers, but also have excellent overall physical properties marking a significant improvement over those materials previously available. The improved properties of the polymers result from the isolated dispersion of the diene comonomer and other comonomers along the sequence of the polymer molecule.

In some embodiments, the ethylene copolymers of the present disclosure have an Mw of about 10,000 g/mol to about 1,100,000 g/mol, such as about 100,000 g/mol to about 600,000 g/mol, such as about 100,000 g/mol to about 350,000 g/mol, such as about 150,000 g/mol to about 300,000 g/mol, such as about 200,000 g/mol to about 300,000 g/mol, alternatively about 300,000 g/mol to about 400,000 g/mol, alternatively about 400,000 g/mol to about 500,000 g/mol.

In some embodiments, the ethylene copolymers of the present disclosure have an Mn of about 1,000 g/mol to about 1,000,000 g/mol, such as about 2,500 g/mol to about 50,000 g/mol, such as about 5,000 g/mol to about 25,000 g/mol, such as about 7,500 g/mol to about 15,000 g/mol, such as about 9,000 g/mol to about 13,000 g/mol.

In some embodiments, the ethylene copolymers of the present disclosure have about 0.01 mol % to about 10 mol % cyclopentane along the backbone of the polymer, such as about 0.1 mol % to about 7 mol %, such as about 0.2 mol % to about 5 mol %, such as about 0.3 mol % to about 3.5 mol %, such as about 0.35 mol % to about 0.4 mol %.

In some embodiments, the ethylene copolymers of the present disclosure have about 0.1 mol % to about 5 mol % butadiene in the 1,2 configuration along the backbone of the polymer, such as about 0.5 mol % to about 4 mol %, such as about 1 mol % to about 3 mol %.

In some embodiments, the ethylene copolymers of the present disclosure have about 0.01 mol % to about 10 mol % butadiene in the 1,4-trans configuration along the backbone of the polymer, such as about 0.5 mol % to about 8 mol %, such as about 1 mol % to about 6 mol %, such as about 2 mol % to about 5 mol %, such as about 3 mol % to about 4 mol %.

In some embodiments, the ethylene copolymers of the present disclosure have about 0.5 mol % to about 40 mol % butadiene in the 1,4-cis configuration along the backbone of the polymer, such as about 1 mol % to about 35 mol %, such as about 5 mol % to about 35 mol %, such as about 10 mol % to about 30 mol %, such as about 20 mol % to about 25 mol %.

In some embodiments, the ethylene copolymers of the present disclosure have an Mw/Mn (PDI) value of about 2 to about 65, such as about 5 to about 55, such as about 10 to about 40, such as about 15 to about 35, alternatively about 20 to about 30.

In some embodiments, a molar ratio of activator(s) to polymerization catalyst is about 1:1 to about 80:1, such as about 40:1 to about 60:1. It is noted that increasing the activator content relative to the catalyst compound results in increased catalyst activity. Additionally, increasing activator content relative to catalyst leads to lower Mw of the polymer products, thus allowing for accurate control of the Mw in the polymerization process. This is consistent with the coordinative chain transfer mechanism of polymerization.

In some embodiments, the ethylene copolymers have a glass transition temperature (Tg) of about −105° C. to about −100° C., such as about −101° C. to about −104° C., to about −102° C. to about −103° C.

In some embodiments, the ethylene copolymers have a thermal melting temperature (Tm) of about 90° C. to about 140° C., such as about 100° C. to about 125° C., such as about 115° C. to about 125° C. In some embodiments, the ethylene copolymers have two thermal melting temperatures simultaneously.

### Polymer Functionalization

In some instances, it may be desirable to incorporate polar groups along the backbone of the polymer such that subsequent reactions can take place after the polymerization. In some embodiments, the polymerizations described herein further include utilizing a third monomer that is a metal hydrocarbenyl transfer agent (which is any group 12 or 13 metal agent that contains at least one transferrable group that has an allyl chain end), such as an aluminum vinyl-transfer agent, also referred to as an AVTA, (which is any aluminum agent that contains at least one transferrable group that has an allyl chain end).

Suitable catalyst systems of the present disclosure can have high rates of olefin propagation and negligible or no chain termination via beta hydride elimination, beta methyl elimination, or chain transfer to monomer relative to the rate of chain transfer to the AVTA or other chain transfer agent, such as an aluminum alkyl, if present.

In some embodiments, the concentrations of aluminum vinyl monomer in a polymerization process of the present disclosure can be about 0.01 mol % to about 10.0 mol %, such as about 0.1 wt % to about 5 wt %.

In at least one embodiment of the present disclosure, the aluminum vinyl transfer agent, which is represented by the Formula (A):

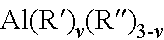

where R′ is a hydrocarbyl group containing 1 to 30 carbon atoms, R″ is a hydrocarbenyl group containing 4 to 20 carbon atoms having an allyl chain end, and v is 0.1 to 3, alternately 1 to 3, alternately 1.1 to less than 3, alternately v is 0.5 to 2.9, 1.1 to 2.9, alternately 1.5 to 2.7, alternately 1.5 to 2.5, alternately 1.8 to 2.2. Suitable compounds represented by the formula Al(R′)₃₋ᵥ(R″)ᵥ are neutral species, but anionic formulations may be envisioned, such as those represented by formula (B): [Al(R′)_{4-w}(R″)_{w}]—, where w is 0.1 to 4, R′ is a hydrocarbyl group containing 1 to 30 carbon atoms, and R″ is a hydrocarbenyl group containing 4 to 20 carbon atoms having an allyl chain end.

In at least one embodiment of any formula for an aluminum vinyl transfer agent, described herein, each R′ is independently chosen from C₁ to C₃₀ hydrocarbyl groups (such as a C₁ to C₂₀ alkyl groups, such as methyl, ethyl, propyl, butyl, pentyl, hexyl, heptyl, octyl, nonyl, decyl, undecyl, dodecyl, or an isomer thereof), and R″ is represented by the formula:

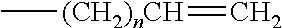

where n is an integer from 2 to 18, such as 6 to 18, such as 6 to 12, such as 6.

Aluminum vinyl transfer agents can include one or more of tri(but-3-en-1-yl)aluminum, tri(pent-4-en-1-yl)aluminum, tri(oct-7-en-1-yl)aluminum, tri(non-8-en-1-yl)aluminum, tri(dec-9-en-1-yl)aluminum, tri(dodec-11-en-1-yl)aluminum, dimethyl(oct-7-en-1-yl)aluminum, diethyl(oct-7-en-1-yl)aluminum, dibutyl(oct-7-en-1-yl)aluminum, diisobutyl(oct-7-en-1-yl)aluminum, diisobutyl(non-8-en-1-yl)aluminum, dimethyl(dec-9-en-1-yl)aluminum, diethyl(dec-9-en-1-yl)aluminum, dibutyl(dec-9-en-1-yl)aluminum, diisobutyl(dec-9-en-1-yl)aluminum, and diisobutyl(dodec-11-en-1-yl)aluminum, methyl-di(oct-7-en-1-yl)aluminum, ethyl-di(oct-7-en-1-yl)aluminum, butyl-di(oct-7-en-1-yl)aluminum, isobutyl-di(oct-7-en-1-yl)aluminum, isobutyl-di(non-8-en-1-yl)aluminum, methyl-di(dec-9-en-1-yl)aluminum, ethyl-di(dec-9-en-1-yl)aluminum, butyl-di(dec-9-en-1-yl)aluminum, isobutyl-di(dec-9-en-1-yl)aluminum, and isobutyl-di(dodec-11-en-1-yl)aluminum.

In at least one embodiment of the present disclosure, particularly useful AVTAs include, but are not limited to, tri(but-3-en-1-yl)aluminum, tri(pent-4-en-1-yl)aluminum, tri(oct-7-en-1-yl)aluminum, tri(non-8-en-1-yl)aluminum, tri(dec-9-en-1-yl)aluminum, dimethyl(oct-7-en-1-yl)aluminum, diethyl(oct-7-en-I-yl)aluminum, dibutyl(oct-7-en-1-yl)aluminum, diisobutyl(oct-7-en-1-yl)aluminum, diisobutyl(non-8-en-1-yl)aluminum, diisobutyl(dec-9-en-1-yl)aluminum, diisobutyl(dodec-i i-en-1-yl)aluminum, and the like. Mixtures of one or more AVTAs may also be used. In some embodiments of the present disclosure, isobutyl-di(oct-7-en-1-yl)-aluminum, isobutyl-di(dec-9-en-1-yl)-aluminum, isobutyl-di(non-8-en-1-yl)-aluminum, isobutyl-di(hept-6-en-1-yl)-aluminum are suitable.

Aluminum vinyl transfer agents can include organoaluminum compound reaction products between aluminum reagent (AlR₃) and an alkyl diene. Suitable alkyl dienes include those that have two “alpha olefins”, as described above, at two termini of the carbon chain. The alkyl diene can be a straight chain or branched alkyl chain and substituted or unsubstituted. Exemplary alkyl dienes include but are not limited to, for example, 1,3-butadiene, 1,4-pentadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 1,14-pentadecadiene, 1,15-hexadecadiene, 1,16-heptadecadiene, 1,17-octadecadiene, 1,18-nonadecadiene, 1,19-eicosadiene, 1,20-heneicosadiene, etc. Exemplary aluminum reagents include triisobutylaluminum, diisobutylaluminumhydride, isobutylaluminumdihydride and aluminum hydride (AlH₃). Useful compounds can be prepared by combining an aluminum reagent (such as alkyl aluminum) having at least one secondary alkyl moiety (such as triisobutylaluminum) and/or at least one hydride, such as a dialkylaluminum hydride, a monoalkylaluminum dihydride or aluminum trihydride (aluminum hydride, AlH₃) with an alkyl diene and heating to a temperature that causes release of an alkylene byproduct. The use of solvent(s) is not required. However, non-polar solvents can be employed, such as, as hexane, pentane, toluene, benzene, xylenes, and the like, or combinations thereof. In at least one embodiment of the present disclosure, the AVTA is free of coordinating polar solvents such as tetrahydrofuran and diethylether. After the reaction is complete, solvent if present, can be removed and the product can be used directly without further purification.

In at least one embodiment, R″ of Formula (A) is butenyl, pentenyl, heptenyl, octenyl or decenyl, such as R″ is octenyl or decenyl. R′ of Formula (A) can be methyl, ethyl, propyl, isobutyl, or butyl, such as R′ is isobutyl.

In at least one embodiment of the present disclosure, v of Formula (A) is about 2, or v is 2.

In at least one embodiment, v of Formula (A) is about 1, or v is 1, such as from about 1 to about 2.

In some embodiments, v of Formula (A) can be an integer or a non-integer, such as v is from 1.1 to 2.9, such as from about 1.5 to about 2.7, e.g., such as from about 1.6 to about 2.4, such as from about 1.7 to about 2.4, such as from about 1.8 to about 2.2, such as from about 1.9 to about 2.1 and all ranges there between.

In at least one embodiment of the present disclosure, R′ is isobutyl and each R″ is octenyl or decenyl, and v is from 1.1 to 2.9, such as from about 1.5 to about 2.7, such as from about 1.6 to about 2.4, such as from about 1.7 to about 2.4, such as from about 1.8 to about 2.2, such as from about 1.9 to about 2.1.

The amount of v is described using the formulas: (3-v)+v=3, and Al(R′)ᵥ(R″)₃₋ᵥ where R″ is a hydrocarbenyl group containing 4 to 20 carbon atoms having an allyl chain end, R′ is a hydrocarbyl group containing 1 to 30 carbon atoms, and v is 0.1 to 3 (such as 1.1 to 3). This formulation represents the observed average of organoaluminum species (as determined by ¹H NMR) present in a mixture, which may include any of Al(R′)₃, Al(R′)₂(R″), Al(R′)(R″)₂, and Al(R″)₃. In still another aspect, the aluminum vinyl-transfer agent has less than 50 wt % dimer present, based upon the weight of the AVTA, such as less than 40 wt %, such as less than 30 wt %, such as less than 20 wt %, such as less than 15 wt %, such as less than 10 wt %, such as less than 5 wt %, such as less than 2 wt %, such as less than 1 wt %, such as 0 wt % dimer. Alternately dimer is present at from 0.1 to 50 wt %, alternately 1 to 20 wt %, alternately at from 2 to 10 wt %. Dimer is the dimeric product of the alkyl diene used in the preparation of the AVTA. The dimer can be formed under certain reaction conditions, and is formed from the insertion of a molecule of diene into the Al—R bond of the AVTA, followed by beta-hydride elimination. For example, if the alkyl diene used is 1,7-octadiene, the dimer is 7-methylenepentadeca-1,14-diene. Similarly, if the alkyl diene is 1,9-decadiene, the dimer is 9-methylenenonadeca-1,18-diene.

For polymerizations of the present disclosure, the molar ratio of AVTA to catalyst complex can be greater than 5, alternately greater than 10, alternately greater than 15, alternately greater than 20, alternately greater than 25, alternately greater than 30.

In at least one embodiment of the present disclosure, the metal hydrocarbenyl chain transfer agent is represented by the formula: Al(R′)₃-v(R″)ᵥ where each R′ independently is a C₁-C₃₀ hydrocarbyl group, each R″, independently, is a C₄-C₂₀ hydrocarbenyl group having an end-vinyl group, and v is from 0.1 to 3, such as each R″, independently, is a C₄-C₂₀ hydrocarbenyl group having an allyl chain end and v is from 0.1 to 3, such as v=2.

The production of in-chain functionalized ethylene/butadiene copolymers is possible with this technology. Additionally, the process disclosed herein allows for in-chain functionalization of ethylene/butadiene copolymers within a single reactor. The Al-carbon bonds can react with a variety of electrophiles (and other reagents), such as oxygen, halogens, carbon dioxide, and the like to form functionalized vinyl transfer agent units. For example, the Al-carbon bonds react with carbon dioxide to form carbon dioxide functionalized vinyl transfer agent units.

In some embodiments, polymers with functionalized vinyl transfer agent units of the present disclosure have Tm about 90° C. to about 130° C., such as about 103° C. to about 122° C.

### ¹³C NMR

Samples can be dissolved in deuterated 1,1,2,2-tetrachloroethane (tce-d2) at a concentration of 34 mg/mL at 140° C. Spectra can be recorded at 120° C. using a Bruker NMR spectrometer of at least 600 MHz with a 10 mm cryoprobe. A 90° pulse, 10 s delay, 512 transients, and gated decoupling can be used for measuring the ¹³C NMR spectra. Polymer resonance peaks are referenced to polyethylene main peak at 29.98 ppm. Assignments of the spectra can be based on the following literature references: Llauro et. al., Macromolecules, v. 34(18), (2001), pp. 6304-6311; Makhiyanov, Polymer Sci, (2012), pp. 60-90 and Longo et. al., Macromolecules, v. 36, (2003), pp. 9067-6074.

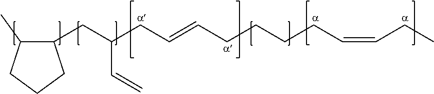

Calculations of composition used the following signals:

| | Chemical | | |
|---|---|---|---|
| Assignment | Shifts (ppm) | Calculations | Mole % |
| C₅ ring (cC₅) | 46.4, 35.7, 24.3 | cC₅ = (46.4 + 35.5 + 24.3)/5 | cC₅/total moles*100 |
| 1,2 butadiene CH | 43.3 ppm | 1,2 | 1,2/total moles*100 |
| Trans 1,4 butadiene | 32.5 ppm | trans = α′ position/2 | trans/total moles*100 |
| (α′ position) | | | |
| Cis 1,4 butadiene | 27.5 ppm | cis = α position/2 | cis/total moles*100 |
| (α position) | | | |
| Ethylene | 28-30 ppm | E = (28-30)/2 | E/total moles*100 |
| Total Mole | | | cC5 + 1,2 + trans + cis + E |

### ¹H NMR

Samples can be dissolved in deuterated 1,1,2,2-tetrachloroethane (tce-d2) at a concentration of at least 30 mg/mL at 140° C. Spectra can be recorded at 120° C. using a Bruker NMR spectrometer of at least 600 MHz with a 10 mm cryoprobe. A 30° pulse, 5 s delay, and 512 transients, can be used for measuring the ¹H NMR. Peaks can be referenced to the residual solvent peak at 5.98 ppm.

| | Chemical | | | |
|---|---|---|---|---|
| Assignment | Shifts (ppm) | Name | Calculations | Mole % |
| 1,2 butadiene | 5.5-5.6 ppm | 1,2 | 1,2 | 1,2/total moles*100 |
| CH db | | | | |
| 1,4 butadiene | 5.30-5.45 ppm | 1,4 | 1,4 | 1,4/total moles*100 |
| CH db | | | | |
| Ethylene | 3-0 ppm | Aliph | E = (Aliph-4*1,4-3*1,2)/4 | E/total moles*100 |
| Total Mole | | | | 1,2 + 1,4 + E |

### GPC-4D:

Unless otherwise indicated, the distribution and the moments of molecular weight (Mw, Mn, Mz, Mw/Mn, etc.) and the comonomer content are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering about 2700 cm⁻¹ to about 3000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ~300 ppm antioxidant 2,6-di-tert-butyl-4-methoxyphenol (BHT) can be used as the mobile phase at a nominal flow rate of ~1.0 mL/min and a nominal injection volume of ~200 μL. The whole system including transfer lines, columns, and detectors can be contained in an oven maintained at ~145° C. A given amount of sample can be weighed and sealed in a standard vial with ~10 μL flow marker (heptane) added thereto. After loading the vial in the auto-sampler, the oligomer or polymer may automatically be dissolved in the instrument with ~8 mL added TCB solvent at ~160° C. with continuous shaking. The sample solution concentration can be from ~0.2 to ~2.0 mg/ml, with lower concentrations used for higher molecular weight samples. The concentration, c, at each point in the chromatogram can be calculated from the baseline-subtracted IR5 broadband signal, I, using the equation: c=αI, where a is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, a and K for other materials are as calculated by GPC ONE™ software (Polymer Characterization, S. A., Valencia, Spain). Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

$$w 2 = f * S C B / 1000 TC$$

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk I R ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000TC (bulk CH3end/1000TC) is obtained by weight-averaging the chain-end correction over the molecular-weight range. Then

$$w 2 b = f * CH 3 / 1000 TC$$

$$bulk S C B / 1000 TC = bulk CH 3 / 1000 TC - bulk CH 3 end / 1000 TC$$

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A² is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where NA is Avogadro's number, and (dn/dc) is the refractive index increment for the system, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1-0.00126*w2) ml/mg and A2=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, fs, for the solution flowing through the viscometer is calculated from their outputs. The intrinsic viscosity, [η], at each point in the chromatogram is calculated from the equation [η]=ηs/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

### Tires

In some embodiments, copolymers of the present disclosure can be used as a component of a tire. A tire (also referred to as a “tire product” herein) can be any suitable tire, such as a rubber tire having an outer (visible) rubber sidewall layer where the outer sidewall layer includes a copolymer of the present disclosure. The tire can be built, shaped, molded to include the outer sidewall (rubber sidewall layer) and cured by various methods which will be readily apparent to those having skill in such art.

Blends of highly saturated specialty elastomers blended with highly unsaturated polymers can be desired to improve the performance window of the blend (e.g., oxygen & ozone resistance, thermal stability, tack, etc.). For tire tread in particular, tire tread compounds in a tire dictate properties of the tire, such as wear, traction, and rolling resistance. It is a technical challenge to deliver excellent traction, low rolling resistance while providing good tread wear. The challenge lies in the trade-off between wet traction and rolling resistance/tread wear.

Because a need for filler to be introduced to the ultimate tire product is reduced or eliminated using methods of the present disclosure, the reduction or absence of filler in the tire product provides improved wear resistance, for example reduced or eliminated cracking initiation and propagation, of the tire product (tire tread).

The term “filler” as used herein refers to any material that is used to reinforce or modify physical properties of a composition (as a tire product), impart certain processing properties, or reduce cost of a tire.

Examples of inorganic filler include calcium carbonate, clay, mica, silica, silicates, talc, titanium dioxide, alumina, zinc oxide, starch, wood flour, or combination(s) thereof. The fillers may be any size and range, for example in the tire industry, from 0.0001 m to 100 m.

As used herein, the term “silica” is meant to refer to any type or particle size silica or another silicic acid derivative, or silicic acid, processed by solution, pyrogenic, or the like methods, including untreated, precipitated silica, crystalline silica, colloidal silica, aluminum or calcium silicates, fumed silica, and the like. Precipitated silica can be conventional silica, semi-highly dispersible silica, or highly dispersible silica. A filler can be commercially available by Rhodia Company under the trade name ZEOSIL™ Z1165 or ZEOSIL™ 1165 MP.

Because functionalized copolymers of the present disclosure can provide improved interactions between the copolymer and additive(s), less additive can be used as compared to conventional tire compositions. In some embodiments, a composition (as a tire product) includes, per 100 parts by weight of rubber (phr), less than 150 phr, such as about 10 to about 150 phr filler (such as silica). In another embodiment, a composition (as a tire product) includes, about 30 to about 130 phr of filler. In a further embodiment, a composition includes, about 50 to about 90 phr filler.

### EXAMPLES

### Synthesis of Catalysts

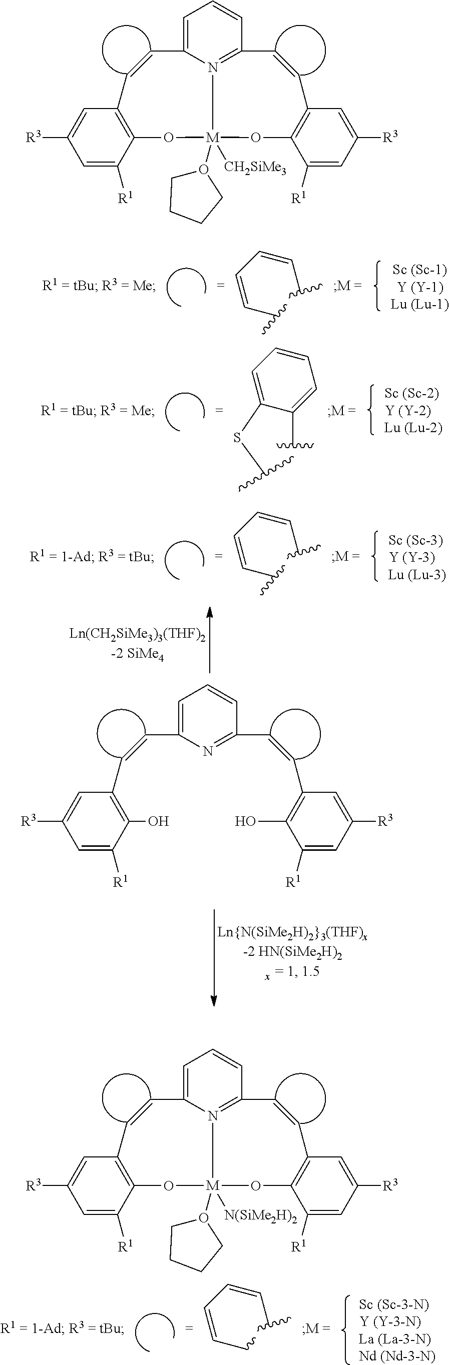

Ln(Me₃SiCH₂)₃(THF)₂ (Ln=Sc, Y, Lu) were synthesized from (trimethylsilyl)methyllithium (0.7M in hexanes; Acros Organics) and anhydrous LnCl₃ (Aldrich) and as described in Chemical Communications 2016, v. 52(31), pp. 5425-5427. Ln(N(SiMe₂H)₂)₃(THF)ₙ (Ln=Sc, Y, La, Nd) were prepared as described in literature (Organometallics 2013, v. 32, pp. 1528-1530 and J. Org. Chem. 2007, v. 72(23), pp. 8648-8655). The ligand precursor, 2′,2′″-(pyridine-2,6-diyl)bis(3-(tert-butyl)-5-methyl-[1,1′-biphenyl]-2-ol), was synthesized as described in WO2020/167824. The ligand precursor, 6,6′-(pyridine-2,6-diylbis(benzo[b]thiophene-3,2-diyl))bis(2-(tert-butyl)-4-methylphenol), was synthesized as described in WO2020/167819. The ligand precursor, 2′,2′″-(pyridine-2,6-diyl)bis(3-(adamantan-1-yl)-5-(tert-butyl)-[1,1′-biphenyl]-2-ol), was synthesized as described in U.S. Pat. No. 11,254,763. All other reagents are commercially available, and all solvents were dried and de-gassed prior to use using typical methods previously reported. Metal complexes, also referred to as catalysts, and pre-catalysts, were prepared under an inert atmosphere.

### Example 1. Synthesis of Complex Y-1

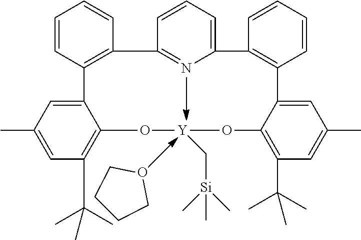

In a 20 ml scintillation vial, to a suspension of 204 mg (0.368 mmol) of 2′,2′″-(pyridine-2,6-diyl)bis(3-(tert-butyl)-5-methyl-[1,1′-biphenyl]-2-ol) in 10 ml of hexane, 182 mg of Y(Me₃SiCH₂)₃(THF)₂ (0.368 mmol) was added in one portion at −30° C. The resulting mixture was stirred at room temperature for 6 hours, and the vial was brought to fridge (−30° C.). After 12 hours, the precipitate was filtered off using a syringe filter (0.45 um PTFE), and the mother liquor was put back into the fridge. After 12 hours, the precipitate formed was filtered off using a syringe filter (0.45 um PTFE), and the mother liquor was evaporated to dryness to give 145 mg (49%) of the product as a beige powder. Anal. Calc. for C₄₇H₅₈YNO₃Si: C, 70.39; H, 7.29; N, 1.75. Found: C 70.65; H 7.68; N 1.51. ¹H NMR (400 MHz, benzene-d₆): δ 7.53 (dd, J=7.5, 1.3 Hz, 1H), 7.18-7.38 (m, 6H), 6.94-7.06 (m, 4H), 6.88 (dd, J=7.8, 1.1 Hz, 1H), 6.66 (d, J=2.3 Hz, 1H), 6.52 (t, J=7.8 Hz, 1H), 6.32 (dd, J=7.8, 1.1 Hz, 1H), 3.69-3.75 (m, 2H), 3.57-3.63 (m, 2H), 2.28 (s, 3H), 2.20 (s, 3H), 1.67 (s, 9H), 1.56 (s, 9H), 1.11-1.14 (m, 4H), 0.27 (s, 9H), −0.41 (dd, J=11.4, 3.9 Hz, 1H), −2.05 (dd, J=11.4, 4.0 Hz, 1H).

### Example 2. Synthesis of Complex Sc-1

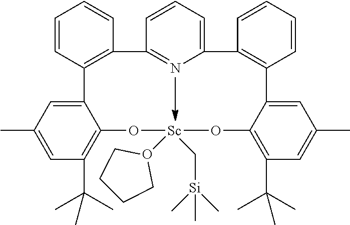

In a 20 ml scintillation vial, to a suspension of 150 mg (0.270 mmol) of 2′,2′″-(pyridine-2,6-diyl)bis(3-(tert-butyl)-5-methyl-[1,1′-biphenyl]-2-ol) in 10 ml of hexane, 121 mg of Sc(Me₃SiCH₂)₃(THF)₂ (0.270 mmol) was added in one portion at −30° C. The resulting solution was stirred at room temperature for 6 hours, and the vial was brought to fridge (−30° C.). After 12 hours, the precipitate was filtered off using a syringe filter (0.45 um PTFE), and the mother liquor was put back in the fridge. After 12 hours, the formed precipitate was filtered off using a syringe filter (0.45 um PTFE), and the mother liquor was evaporated to dryness to give 125 mg (66%) of the product as an off-white solid. Anal. Calc. for C₄₇H₅₈ScNO₃Si: C, 74.47; H, 7.71; N, 1.85. Found: C 74.80; H 7.58; N 1.74. ¹H NMR (400 MHz, benzene-d₆): δ 7.49 (d, J=7.3 Hz, 1H), 7.35 (dt, J=7.2, 2.1 Hz, 1H), 7.22-7.30 (m, 4H), 7.20 (d, J=7.6 Hz, 1H), 7.08 (dt, J=7.5, 1.4 Hz, 1H), 7.00 (dt, J=7.5, 1.4 Hz, 1H), 6.97 (d, J=2.1 Hz, 1H), 6.86 (dd, J=7.4, 1.2 Hz, 1H), 6.72 (dd, J=7.6, 1.1 Hz, 1H), 6.67 (d, J=1.9 Hz, 1H), 6.52 (t, J=7.8 Hz, 1H), 6.26 (d, J=7.8 Hz, 1H), 3.88-3.94 (m, 2H), 3.75-3.81 (m, 2H), 2.25 (s, 3H), 2.18 (s, 3H), 1.64 (s, 9H), 1.57 (s, 9H), 1.15-1.22 (m, 4H), 0.26 (d, J=11.6 Hz, 1H), 0.23 (s, 9H), −1.90 (d, J=11.6 Hz, 1H). ¹³C NMR (400 MHz, benzene-d₆): δ158.8, 158.7, 145.0, 143.3, 138.7, 138.6, 138.0, 137.4, 136.1, 135.6, 133.4, 132.2, 131.5, 131.2, 130.7, 130.65, 130.6, 129.7, 127.7, 127.1, 124.5, 124.4, 123.8, 123.0, 73.1, 35.8, 35.7, 31.9, 30.7, 25.4, 21.4, 21.3, 4.4.

### Example 3. Synthesis of Complex Lu-1

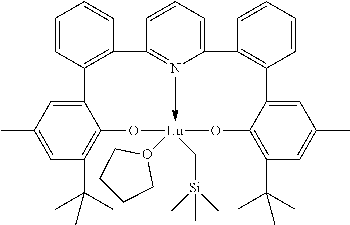

In a 20 ml scintillation vial, to a suspension of 86 mg (0.155 mmol) of 2′,2′″-(pyridine-2,6-diyl)bis(3-(tert-butyl)-5-methyl-[1,1′-biphenyl]-2-ol) in 10 ml of hexane, 90 mg of Lu(Me₃SiCH₂)₃(THF)₂ (0.155 mmol) was added in one portion at −30° C. The resulting solution was stirred at room temperature for 6 hours, and the vial was brought to fridge (−30° C.). After 12 hours, the precipitate was filtered off using a syringe filter (0.45 um PTFE), and the mother liquor was put back in the fridge. After 12 hours, the formed precipitate was filtered off using a syringe filter (0.45 um PTFE), and the mother liquor was evaporated to dryness to yield 113 mg (82%) of the product as an off-white solid. Anal. Calc. for C₄₇H₅₈LuNO₃Si: C, 63.57; H, 6.58; N, 1.58. Found: C 63.85; H 6.82; N 1.37. ¹H NMR (400 MHz, benzene-d₆): δ 7.50 (d, J=7.5 Hz, 1H), 7.36 (dt, J=7.4, 1.6 Hz, 1H), 7.26-7.30 (m, 2H), 7.20-7.26 (m, 3H), 7.00-7.09 (m, 3H), 6.95 (dd, J=7.3, 1.5 Hz, 1H), 6.72 (dd, J=7.8, 1.0 Hz, 1H), 6.64 (d, J=1.8 Hz, 1H), 6.51 (t, J=7.8 Hz, 1H), 6.30 (dd, J=7.8, 1.0 Hz, 1H), 3.73-3.79 (m, 2H), 3.63-3.67 (m, 2H), 2.28 (s, 3H), 2.19 (s, 3H), 1.68 (s, 9H), 1.53 (s, 9H), 1.11-1.16 (m, 4H), 0.26 (s, 9H), −0.65 (d, J=11.7 Hz, 1H), −2.24 (d, J=11.7 Hz, 1H). ¹³C NMR (400 MHz, benzene-d₆): δ 162.3, 160.3, 158.93, 158.86, 144.9, 143.8, 138.9, 138.8, 137.8, 136.7, 136.5, 136.1, 133.0, 131.5, 131.4, 131.3, 131.0, 130.95, 130.1, 129.8, 127.7, 127.1, 124.7, 123.8, 123.0, 122.98, 72.5, 35.8, 35.6, 31.7, 31.6, 30.9, 30.5, 25.4, 21.5, 21.3, 5.0.

### Example 4. Synthesis of Complex Y-2

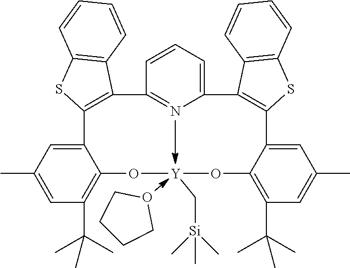

In a 20 ml scintillation vial, to a suspension of 135 mg (0.202 mmol) of 6,6′-(pyridine-2,6-diylbis(benzo[b]thiophene-3,2-diyl))bis(2-(tert-butyl)-4-methylphenol) in 10 ml of hexane and 0.5 ml of toluene, 100 mg of Y(Me₃SiCH₂)₃(THF)₂ (0.202 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the formed precipitate was filtered off using a syringe filter (0.45 um PTFE), and the mother liquor was evaporated to dryness to yield 124 mg (67%) of the product as an off-white solid. Anal. Calc. for C₅₁H₅₈YNS₂O₃Si: C, 67.01; H, 6.40; N, 1.53. Found: C 66.85; H 6.65; N 1.31. ¹H NMR (400 MHz, benzene-d6): δ 7.61 (d, J=7.9 Hz, 1H), 7.55 (d, J=7.9 Hz, 1H), 7.51 (d, J=7.9 Hz, 1H), 7.36 (d, J=2.0 Hz, 1H), 7.28 (dt, J=7.5, 1.1 Hz, 1H), 7.17-7.21 (m, 2H), 6.93-7.10 (m, 5H), 6.77 (t, J=7.8 Hz, 1H), 6.28 (dd, J=7.7, 1.1 Hz, 1H), 6.21 (d, J=7.7 Hz, 1H), 3.80-3.93 (m, 4H), 2.26 (s, 3H), 2.22 (s, 3H), 1.48 (s, 9H), 1.09-1.15 (m, 4H), 1.05 (s, 9H), 0.19 (s, 9H), −0.59 (dd, J=11.3, 3.9 Hz, 1H), −2.18 (dd, J=11.3, 4.0 Hz, 1H). ¹³C NMR (400 MHz, benzene-d6): δ 162.9, 160.1, 156.9, 153.8, 152.0, 145.8, 142.6, 141.7, 140.2, 139.6, 139.4, 136.9, 130.6, 130.3, 130.1, 130.0, 129.6, 126.2, 125.8, 125.6, 125.5, 124.9, 124.6, 124.3, 123.6, 123.5, 123.2, 123.1, 122.8, 122.7, 122.2, 72.0, 35.8, 35.3, 30.4, 30.2, 29.9, 29.5, 25.2, 21.34, 21.31, 4.6.

### Example 5. Synthesis of Complex Sc-2

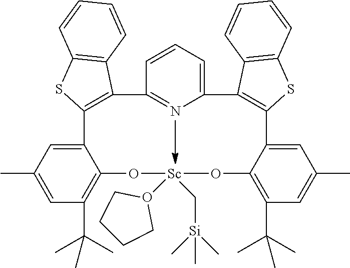

In a 20 ml scintillation vial, to a suspension of 170 mg (0.255 mmol) of 6,6′-(pyridine-2,6-diylbis(benzo[b]thiophene-3,2-diyl))bis(2-(tert-butyl)-4-methylphenol) in 10 ml of hexane and 0.5 ml of toluene, 115 mg of Sc(Me₃SiCH₂)₃(THF)₂ (0.255 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the precipitate was filtered off using a syringe filter (0.45 um PTFE), and the mother liquor was evaporated to dryness to yield 127 mg (57%) of the product as an off-white solid. Anal. Calc. for C₅₁H₅₈ScNS₂O₃Si: C, 70.39; H, 6.72; N, 1.61. Found: C 70.68; H 6.98; N 1.50. ¹H NMR (400 MHz, benzene-d6): δ 7.73 (d, J=8.0 Hz, 1H), 7.55 (d, J=8.0 Hz, 1H), 7.51 (d, J=8.0 Hz, 1H), 7.40 (d, J=1.7 Hz, 1H), 7.31 (dt, J=7.2, 1.0 Hz, 1H), 7.15-7.21 (m, 2H), 7.00-7.14 (m, 5H), 6.91 (dt, J=8.0, 1.0 Hz, 1H), 6.79 (t, J=7.8 Hz, 1H), 6.22 (dd, J=7.7, 1.1 Hz, 1H), 6.11 (d, J=7.8 Hz, 1H), 4.10-4.17 (m, 2H), 3.97-4.05 (m, 2H), 2.25 (s, 3H), 2.21 (s, 3H), 1.50 (s, 9H), 1.15-1.24 (m, 4H), 0.98 (s, 9H), 0.17 (d, J=11.3 Hz, 1H), 0.12 (s, 9H), −1.59 (d, J=11.3 Hz, 1H). ¹³C NMR (400 MHz, benzene-d6): δ 162.6, 159.5, 156.9, 154.3, 151.0, 145.0, 142.9, 141.5, 140.0, 139.7, 139.6, 139.1, 136.8, 132.6, 130.6, 130.2, 129.7, 129.6, 126.0, 125.97, 125.6, 125.4, 125.3, 124.9, 124.2, 124.1, 123.6, 123.5, 123.2, 122.8, 122.3, 72.7, 35.9, 35.3, 30.1, 29.5, 25.2, 21.8, 21.3, 4.1.

### Example 6. Synthesis of Complex Lu-2

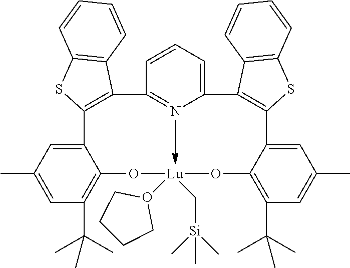

In a 20 ml scintillation vial, to a suspension of 110 mg (0.165 mmol) of 6,6′-(pyridine-2,6-diylbis(benzo[b]thiophene-3,2-diyl))bis(2-(tert-butyl)-4-methylphenol) in 10 ml of hexane and 0.5 ml of toluene, 96 mg of Lu(Me₃SiCH₂)₃(THF)₂ (0.165 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the formed precipitate was filtered off using a syringe filter (0.45 um PTFE), and the mother liquor was evaporated to dryness to give 107 mg (65%) of the product as an off-white solid. Anal. Calc. for C₅₁H₅₈LuNS₂O₃Si: C, 61.24; H, 5.85; N, 1.40. Found: C 61.46; H 6.07; N 1.26. ¹H NMR (400 MHz, benzene-d6): δ 7.65 (d, J=8.0 Hz, 1H), 7.54 (d, J=8.0 Hz, 1H), 7.51 (d, J=8.0 Hz, 1H), 7.38-7.41 (m, 1H), 7.30 (dt, J=7.2, 1.0 Hz, 1H), 7.16-7.22 (m, 2H), 6.90-7.10 (m, 5H), 6.77 (t, J=7.8 Hz, 1H), 6.26 (dd, J=7.7, 1.0 Hz, 1H), 6.16 (d, J=7.9 Hz, 1H), 3.93-4.01 (m, 2H), 3.84-3.93 (m, 2H), 2.27 (s, 3H), 2.23 (s, 3H), 1.47 (s, 9H), 1.11-1.16 (m, 4H), 1.03 (s, 9H), 0.17 (s, 9H), −0.80 (d, J=11.5 Hz, 1H), −2.26 (d, J=11.5 Hz, 1H). ¹³C NMR (400 MHz, benzene-d6): δ 163.6, 161.0, 157.1, 153.9, 151.2, 145.8, 142.8, 141.6, 140.3, 140.0, 139.5, 139.4, 137.4, 131.1, 130.15, 130.12, 129.9, 129.7, 126.2, 126.0, 125.7, 125.67, 125.5, 124.9, 124.6, 124.4, 123.5, 123.4, 123.1, 122.8, 122.7, 122.3, 72.3, 35.8, 35.3, 33.4, 30.4, 30.1, 29.5, 29.4, 25.2, 4.7.

### Example 7. Synthesis of Complex Sc-3

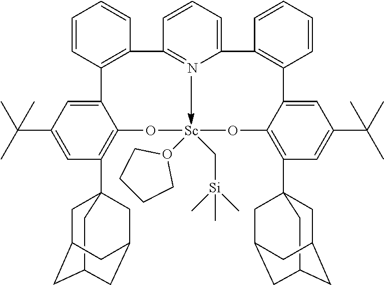

In a 20 ml scintillation vial, to a suspension of 526 mg (0.660 mmol) of 2′,2′″-(pyridine-2,6-diyl)bis(3-(adamantan-1-yl)-5-(tert-butyl)-[1,1′-biphenyl]-2-ol) in 40 ml of hexane and 6.5 ml of toluene, 294 mg of Sc(Me₃SiCH₂)₃(THF)₂ (0.660 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the precipitate was filtered off using a syringe filter (0.45 um PTFE), and the mother liquor was evaporated to give 103 mg (15%) of the product as an off-white solid. Anal. Calc. for C₆₅H₈₂ScNO₃Si: C, 78.20; H, 8.28; N, 1.40. Found: C 78.42; H 8.61; N 1.26. ¹H NMR (400 MHz, benzene-d6): δ 7.67 (d, J=7.2 Hz, 1H), 7.66 (d, J=2.8 Hz, 1H), 7.53 (d, J=2.7 Hz, 1H), 7.39-7.47 (m, 3H), 7.34 (d, J=7.1 Hz, 1H), 7.30 (d, J=2.7 Hz, 1H), 7.19-7.22 (m, 2H), 7.04-7.08 (m, 1H), 6.86-6.90 (m, 2H), 6.65 (t, J=7.8 Hz, 1H), 6.36 (dd, J=7.7, 1.0 Hz, 1H), 3.98-4.06 (m, 2H), 3.68-3.74 (m, 2H), 2.66-2.73 (m, 3H), 2.43-2.63 (m, 6H), 2.30-2.39 (m, 6H), 2.27 (br.s, 3H), 2.14-2.22 (m, 3H), 1.90-2.12 (m, 9H), 1.46 (s, 9H), 1.34 (s, 9H), 1.20-1.28 (m, 4H), 0.31 (s, 9H), 0.14 (d, J=11.4 Hz, 1H), −1.88 (d, J=11.5 Hz, 1H). ¹³C NMR (400 MHz, benzene-d6): δ 161.8, 159.3, 158.3, 158.1, 145.9, 144.5, 138.6, 138.5, 137.7, 137.2, 136.7, 136.0, 135.8, 133.2, 131.7, 131.3, 130.9, 130.8, 130.2, 129.9, 129.7, 127.1, 126.7, 126.0, 125.2, 124.9, 124.0, 123.8, 122.0, 73.1, 42.8, 41.3, 38.7, 38.3, 38.1, 37.8, 34.7, 34.5, 32.5, 32.3, 30.23, 30.18, 25.4, 4.5.

### Example 8. Synthesis of Complex Y-3

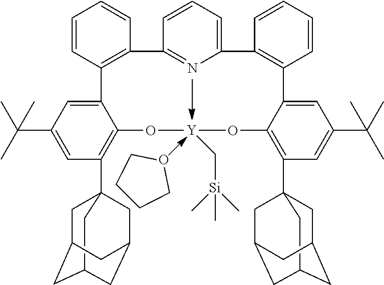

In a 20 ml scintillation vial, to a suspension of 101 mg (0.127 mmol) of 2′,2′″-(pyridine-2,6-diyl)bis(3-(adamantan-1-yl)-5-(tert-butyl)-[1,1′-biphenyl]-2-ol) in 20 ml of n-hexane and 1.5 ml of toluene, 63 mg of Y(Me₃SiCH₂)₃(THF)₂ (0.127 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the precipitate was filtered off using a syringe filter (0.45 um PTFE), and the mother liquor was evaporated to yield 110 mg (83%) of the product as an off-white solid. Anal. Calc. for C₆₅H₈₂YNO₃Si: C, 74.90; H, 7.93; N, 1.34. Found: C 75.27; H 8.12; N 1.19. ¹H NMR (400 MHz, benzene-d6): δ 7.62 (d, J=7.6, 1.0 Hz, 1H), 7.52 (d, J=2.7 Hz, 1H), 7.41 (d, J=2.7 Hz, 1H), 7.37 (dt, J=7.5, 1.5 Hz, 1H), 7.25-7.34 (m, 5H), 7.23 (d, J=2.7 Hz, 1H), 6.97-7.13 (m, 6H), 6.80-6.82 (m, 2H), 6.58 (t, J=7.8 Hz, 1H), 6.32 (dd, J=7.8, 1.0 Hz, 1H), 3.65-3.72 (m, 2H), 3.42-3.50 (m, 2H), 2.60-2.67 (m, 3H), 2.49-2.56 (m, 3H), 2.34-2.41 (m, 3H), 2.16-2.28 (m, 9H), 2.04-2.11 (m, 3H), 1.85-1.93 (m, 9H), 1.38 (s, 9H), 1.26 (s, 9H), 1.04-1.11 (m, 4H), 0.26 (s, 9H), −0.63 (dd, J=11.3, 3.8 Hz, 1H), −2.03 (dd, J=11.3, 3.9 Hz, 1H).

### Example 9. Synthesis of Complex Lu-3

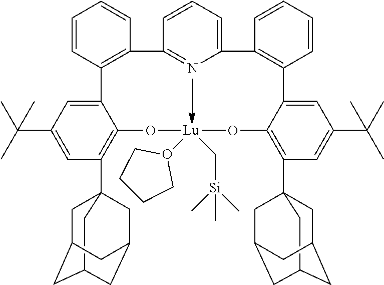

In a 20 ml scintillation vial, to a suspension of 162 mg (0.203 mmol) of 2′,2′″-(pyridine-2,6-diyl)bis(3-(adamantan-1-yl)-5-(tert-butyl)-[1,1′-biphenyl]-2-ol) in 20 ml of hexane and 1.5 ml of toluene, 118 mg of Lu(Me₃SiCH₂)₃(THF)₂ (0.203 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the precipitate was filtered off using a syringe filter (0.45 um PTFE), and the mother liquor was evaporated to dryness to give 200 mg (87%) of the product as an off-white solid. Anal. Calc. for C₆₅H₈₂LuNO₃Si: C, 69.19; H, 7.32; N, 1.24. Found: C 69.43; H 7.44; N 1.28. ¹H NMR (400 MHz, benzene-d6): δ 7.67 (d, J=7.7 Hz, 1H), 7.64 (d, J=2.7 Hz, 1H), 7.52 (d, J=2.7 Hz, 1H), 7.34-7.48 (m, 4H), 7.19-7.21 (m, 2H), 7.11 (d, J=7.3, 2.1 Hz, 1H), 6.92 (dd, J=7.8, 1.0 Hz, 1H), 6.87 (d, J=2.7 Hz, 1H), 6.66 (t, J=7.8 Hz, 1H), 6.41 (dd, J=7.7, 1.0 Hz, 1H), 3.79-3.91 (m, 2H), 3.54-3.64 (m, 2H), 2.69-2.77 (m, 3H), 2.52-2.66 (m, 3H), 2.24-2.48 (m, 12H), 2.13-2.20 (m, 3H), 1.90-2.06 (m, 9H), 1.48 (s, 9H), 1.35 (s, 9H), 1.14-1.21 (m, 4H), 0.34 (s, 9H), −0.78 (d, J=11.5 Hz, 1H), −2.13 (d, J=11.5 Hz, 1H). ¹³C NMR (400 MHz, benzene-d6): δ 162.8, 160.8, 158.5, 158.45, 145.4, 144.9, 138.83, 138.79, 137.1, 137.0, 136.9, 136.6, 136.2, 132.7, 131.2, 131.15, 131.0, 130.9, 130.5, 130.1, 129.7, 127.2, 126.1, 124.8, 124.7, 124.2, 123.7, 122.1, 72.3, 42.6, 42.2, 41.2, 38.6, 38.5, 38.3, 38.2, 38.1, 37.9, 34.7, 34.5, 32.8, 32.6, 32.4, 30.4, 30.3, 30.2, 30.1, 25.5, 5.0.

### Example 10. Synthesis of Complex Sc-3-N

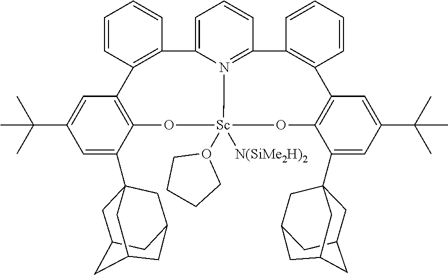

In a 20 mL scintillation vial, [Sc{N(SiMe₂H)₂}₃]·THF (207 mg, 0.4 mmol) was dissolved in 2 mL of THF. Then, solid 2′,2′″-(pyridine-2,6-diyl)bis(3-(adamantan-1-yl)-5-(tert-butyl)-[1,1′-biphenyl]-2-ol) (312 mg, 0.39 mmol) was slowly added while stirring at ambient temperature. After the addition, the reaction mixture was diluted by adding 3 mL THF. The resulting mixture was stirred at 60° C. for 2 hours before the volatiles were removed under nitrogen stream. n-Pentane (5 mL) was added to the pale-yellow oily residue and evaporated to facilitate removing of residual THF. This step was repeated twice to give a pale-yellow powder, which was dissolved in n-pentane (5 mL) and filtered. The filtrate was concentrated to ca ⅕ of the original volume and cooled to −35° C. White crystals were decanted off and dried in vacuum to give 129 mg (33%) of the desired product. The broadness of the resonance signals in ¹H NMR spectrum precludes their accurate integration. ¹H NMR (400 MHz, benzene-d₆): δ 7.47 (d, J=2.7 Hz, 2H), 7.43 (d, J=2.8 Hz, 2H), 7.30-7.11 (m, 6H), 7.01-6.95 (m, 2H), 6.55-6.49 (m, 3H), 4.34 (m, 2H, Si—H), 3.62 (s, 4H, THF), 2.45-2.42 (m, 6H), 2.26-2.21 (m, 12H), 1.97-1.85 (m, 14H), 1.36-1.35 (m, 4H), 1.30 (s, 18H, C(CH₃)₃), 0.20 (d, J=10.8 Hz, 12H, SiMe₂).

### Example 11. Synthesis of Complex Y-3-N

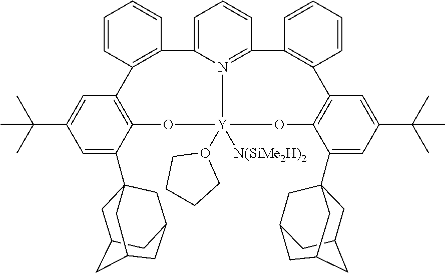

In a 20 mL scintillation vial, [Y{N(SiMe₂H)₂}₃]·1.5THF (235 mg, 0.39 mmol) was dissolved in 2 mL of THF. Then, solid 2′,2′″-(pyridine-2,6-diyl)bis(3-(adamantan-1-yl)-5-(tert-butyl)-[1,1′-biphenyl]-2-ol) (305 mg, 0.38 mmol) was slowly added while stirring at ambient temperature. After the addition, the reaction mixture was diluted by adding 3 mL THF. The resulting mixture was stirred at 60° C. for 2 hours before the volatiles were removed under nitrogen stream. n-Pentane (5 mL) was added to the pale-yellow oily residue and evaporated to facilitate removing of residual THF. This step was repeated twice to give a pale-yellow powder which was dissolved in toluene (1 ml). The resulting solution was layered with n-pentane and stored at −35° C. The precipitated white solid product was collected by filtration and washed twice with cold n-pentane (0.5 mL each). It was then dried in vacuo under a gentle heating (below 40° C.) to give 273 mg of the white solid product (64%). ¹H NMR (400 MHz, benzene-d₆): δ 7.48-7.33 (m, 5H), 7.25-7.00 (m, 6H), 6.85-6.75 (m, 2H), 6.54 (t, 7.5 Hz, 1H) 6.28 (m, 1H), 4.45 (s, 2H, SiH), 3.74-3.45 (m, 4H), 2.61-2.44 (m, 6H), 2.26-2.11 (m, 11H), 1.98 (m, 6H), 1.88-1.85 (m, 7H), 1.37-1.15 (m, 22H), 0.26 (dd, J=18.7 and 2.1 Hz, 12H, SiMe₂).

### Example 12. Synthesis of Complex La-3-N

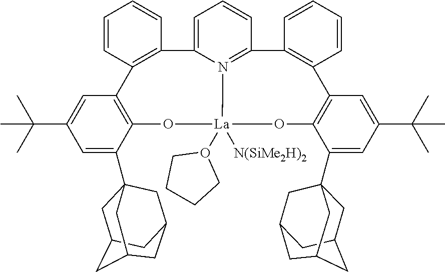

In a 20 mL scintillation vial, [La{N(SiMe₂H)₂}₃]·1.5THF (243 mg, 0.35 mmol) was dissolved in 2 mL of THF. Then, solid 2′,2′″-(pyridine-2,6-diyl)bis(3-(adamantan-1-yl)-5-(tert-butyl)-[1,1′-biphenyl]-2-ol) (273 mg, 0.34 mmol) was slowly added while stirring at ambient temperature. After the addition, the reaction mixture was diluted by adding 3 mL THF. The resulting mixture was stirred at 60° C. for 2 hours before the volatiles were removed under nitrogen stream and heating at 60° C. n-Pentane (5 mL) was added to the pale-yellow oily residue and evaporated to facilitate removing of residual THF and HN(SiMe₂H)₂. This step was repeated five times to give a pale-yellow powder which was washed twice with n-pentane (7 ml each). The resulting product was dissolved in toluene (3 ml) and the obtained solution was subsequently passed through glass microfiber filter and a plug of celite. Concentrating of the filtrate to ca 0.5 mL and layering with n-pentane at −35° C. afforded the precipitation of yellow crystals which were collected by decanting and dried in vacuo for 4 hours to give 297 mg of the product (70%). ¹H NMR (400 MHz, benzene-d₆): δ 7.43-7.40 (m, 4H), 7.29-7.11 (m, 6H), 7.06-6.98 (m, 2H), 6.61-6.54 (m, 3H), 4.48 (sept, 2.9 Hz, 2H, SiH), 3.46 (s, 4H, THF), 2.46-2.16 (m, 18H), 2.02-1.99 (m, 6H), 1.90-1.87 (m, 6H), 1.32 (s, 18H, tBu), 1.16-1.13 (m, 4H), 0.26 (dd, J=22.4 and 3.0 Hz, 12H, SiMe₂).

### Example 13. Synthesis of Complex Nd-3-N

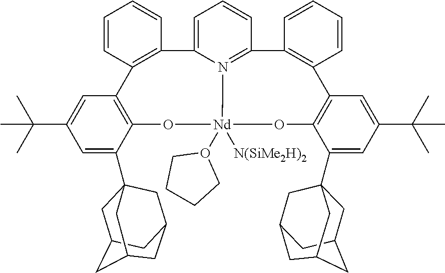

In a 20 mL scintillation vial, [Nd{N(SiMe₂H)₂}₃]·2THF (300 mg, 0.44 mmol) was dissolved in 2 mL of THF. Then, solid 2′,2′″-(pyridine-2,6-diyl)bis(3-(adamantan-1-yl)-5-(tert-butyl)-[1,1′-biphenyl]-2-ol) (342 mg, 0.43 mmol) was slowly added while stirring at ambient temperature. After the addition, the reaction mixture was diluted by adding 3 mL THF. The resulting mixture was stirred at 60° C. for 2 hours before the volatiles were removed under nitrogen stream and heating at 60° C. The obtained bright green oily residue was dissolved in toluene (2 mL) and layered with n-pentane. Blue crystals of the product, solvated with the solvents molecules, (Nd-3-N)·pentane, precipitates from the resulting mixture at −35° C. in 16 hours. Crystals were collected and dried in vacuo to give 119 mg of the greenish solid (25%). Molecular structure of (Nd-3-N)·pentane was confirmed in the crystalline state according to a single-crystal X-ray diffraction study.

### Polymerization Examples

### Example 14 Small Scale Polymerization

In an inert atmosphere in N₂-vented glovebox, catalysts were activated upon addition of iBu₂AlH (DIBAL) and DEATPFPB (DIMAH-1D4) or MAO (13 wt % Al in toluene) in a reaction vessel. The catalyst containing solution was then stirred for about 10 minutes. A solution of butadiene in toluene (10-20 wt %) or isoprene was added (ca ~2500 butadiene eq/catalyst) to the catalyst solution. The reactor was heated to 100° C., stirred at 225 rpm, and then pressurized with ~250 psi ethylene (Sigma, 99.5%). Ethylene was purified by passing through column with an activated adsorbent (AZ-300). The reactor was repressurized when the pressure dropped below 240 psi during the first hour. After 14 hours, the reactor was cooled and then depressurized. For the isolation of polymer products, the contents of each reaction vessel were precipitated and washed with acetone and methanol. The solids were then filtered and washed with copious acetone and methanol. The polymer samples were then dried in a 50° C. vacuum oven for 18 hours.

### Example 15—Polymerization Using Parr Reactor

In a glovebox, catalyst Sc-3 (prepared in Example 7, 20 mg, 0.02 mmol, 1 eq.) was added to an oven-dried glass liner, followed by the addition of DIMAH-D4 (24 mg, 0.03 mmol, 1.5 eq.). Separately, DIBAL (57 microL, 0.32 mmol, 15 eq.) was dissolved in 20 mL toluene, which was then added to the glass liner. The glass liner was placed into the Parr reactor, sealed, and then removed from the glovebox. The reactor was heated to 40° C., and then 80 mL of a toluene solution, containing DIBAL (100 uL, 0.56 mmol, 28 eq.) and 5.41 g of butadiene (100 mmol, 5000 eq., purified by passing through activated basic alumina), was pushed into the reactor using ethylene (100 psi). After reaching 100° C., the ethylene pressure was raised to 250 psi. After a given amount of time, the reactor was cooled and unreacted monomers were vented off. The polymer was precipitated by adding methanol, containing BHT (25 mg) and then washed by successive 100 mL portions of acetone and methanol upon intense agitation. The washed polymer was dried in a vacuum oven at 55° C. for 18 hours.

TABLE 1
Polymerization data for Sc-3 in the Parr reactor.*

| | | Activity | | BD (vinyl/1,4- | | | |
|---|---|---|---|---|---|---|---|
| | Time, | (kg_{polymer}/ | C2, | trans/1,4-cis), | M_{w}, | | |
| Run | h | mol_{Sc}) | mol % | cC5** mol % | kDa | PDI | DSC |
| 1 (unpurified C₂) | 20 | 170.4 | 76 | (2/5/14), 2.8 | 158.2 | 13.21 | Tₘ 118 & |
| | | | | | | | 91° C.; |
| | | | | | | | T_{g} −101° C. |
| 2 | 20 | 457.9 | 84 | (2/3/11), 0.8 | 308.2 | 10.19 | Tₘ 123 & |
| | | | | | | | 112° C.; |
| | | | | | | | T_{g} −103° C. |
| 3 | 2 | 462.0 | 74 | (3/5/19), 0 | 496.5 | 44.9 | Tₘ 125° C.; |
| | | | | | | | T_{g} −103° C. |
| 4 | 1 | 353.0 | 66 | (3/7/25), 0 | 220.9 | 19.68 | Tₘ 125° C.; |
| | | | | | | | T_{g} −103° C. |
| 5 | 0.5 | 258.9 | 46 | (5/9/40), 0 | 208.1 | 21.86 | Tₘ 125° C.; |
| | | | | | | | T_{g} −103° C. |

*Conditions: toluene solution, BD:Sc-3 = 5000:1; 250 psi ethylene; 100° C.; 1.5 eq DIMAH-D4/40 eq DIBAL.
**1,2-trans-cyclopentane.

The polymerization reactions with more uniform mass and heat transfer were performed at 10 g scale in the Parr reactor enabling mechanical stirring. Notably, the catalyst activity is almost 3 times higher when the purified (dried)ethylene feed is used (runs 1 and 2, Table 4). The optimal residence time yielding maximum amount of the polymer (462 kg_{polymer}/mol_{Sc}) was found around 2 hours (run 3). Interestingly, this activity is even higher compared to the highest catalyst activity (405 kg_{polymer}/mol_{Sc}) reported in academic literature for copolymerization of ethylene and butadiene (7). Therefore, the application of bis(phenolate)-catalyst systems for copolymerization is advantageous over metallocene-based catalysts due to the higher productivity.

### Example 16—In-Chain Functionalization

In a glovebox, catalyst Sc-3 (prepared in Example 7, 20 mg, 0.02 mmol, 1 eq.), DIMAH-D4 (24 mg, 0.03 mmol, 1.5 eq.) and DIBAL (57 microL, 0.32 mmol, 15 eq.) were added to an oven-dried glass liner containing 20 mL of toluene. The glass liner was placed into the Parr reactor, sealed, and then removed from the glovebox. Separately, 32 mL of a 19.8 wt % solution of butadiene (5.49 g, 0.10 mol) in toluene was added to a liquid charging system, along with 7-octenyldiisobutylaluminum (1,8-AVTA, 25.2 mg, 252 mg or 1.26 g for 0.1 mol %, 1.0 mol % or 5 mol %, respectively), DIBAL (100 microL) and 48 mL toluene. The Parr reactor was then heated to 40° C. before the solution in the liquid charging system was introduced unto the reactor using 100 psi ethylene. The reaction was stirred for 5 minutes and then reactor was heated to 100° C. and stirred at this temperature for 17 hours. Afterward, the unreacted ethylene and butadiene were vented out and the system was pressurized with CO₂ (200 psi). After stirring for 1.5 hours at 100° C., the reactor was cooled to ambient temperature and residual CO₂ was vented off. The polymer was precipitated by adding methanol, containing 2,6-di-tert-butyl-4-methoxyphenol (BHT, 25 mg) and then washed by successive 100 mL portions of acetone and methanol upon intense agitation. The washed polymer was dried in a vacuum oven at 55° C. for 18 hours.

TABLE 2
Polymerization data for Sc-3 in the presence of 1,8-AVTA .*

| | | | | BD (vinyl/1,4- | | | |
|---|---|---|---|---|---|---|---|
| | 7-octenyldiisobutylaluminum | Activity | | trans/1,4- | | | |
| | (1,8-AVTA) concentration, | (kg_{polymer}/ | C2, | cis), cC5*** | M_{w}, | | |
| Run | mol %** | mol_{Sc}) | mol % | mol % | kDa | PDI | DSC |
| 1 | 0.1 | 543 | 82 | (2/3/13), 0.5 | 255.3 | 11.58 | Tₘ 122° C.; |
| | | | | | | | T_{g} −103 |
| 2 | 1.0 | 357 | 79 | (2/4/15), 1.0 | 134.2 | 11.70 | Tₘ 120 & |
| | | | | | | | 105° C.; |
| | | | | | | | T_{g} −104° C. |
| 3 | 5.0 | 201.6 | 90 | (1/2/5), 1.8 | 40.0 | 2.48 | Tₘ 103° C. |

*Conditions: toluene solution, BD:Sc-3 = 5000:1; 250 psi ethylene; 100° C.; 1.5 eq DIMAH-D4/40 eq DIBAL; 17 h; CO₂-quench: 100° C.; 200 psi CO₂; 1.5 hours;.
**based on butadiene monomer in the reaction mixture.
***1,2-trans-cyclopentane.

Successful incorporation of polar groups into the polymer chain was achieved upon adding 1,8-AVTA (7-octenyldiisobutylaluminum) during the copolymerization with the bis(phenolate)-catalyst system and the subsequent reaction of organoaluminum centers with CO₂. To the best of our knowledge, it is the first example of in-chain functionalization for ethylene/butadiene copolymers performed in a single reactor. Remarkably high catalyst Sc-3 activity was observed for the reaction mixture containing 0.1 mol % of AVTA (543 kg_{polymer}/mol_{Sc}, Table 5, run 1) and producing ethylene-enriched copolymer. Increasing AVTA concentration resulted in lower activity (runs 2 and 3).

### Example 17—Catalyst Screening

The screening of nine group 3 or lanthanide catalysts bearing alkyl or amido groups bonded to the metal center (Scheme 2) activated by two common substrates, DIMAH-D4/DIBAL or MAO, was accomplished at the small scale (ca 1 g of BD) and enabled a fast identification of the most promising catalyst candidate for the further evaluation. Relatively low activity was observed for catalysts (up to 43 kg_{polymer}/mol_{Ln}) featuring 2-tBu-4-Me-phenolate fragment (Table 1, runs 1-6). Catalysts Y-1, Sc-2 and Y-2 copolymerize ethylene and butadiene only when activated with MAO and give ethylene-rich products with low incorporation of butadiene (<1.2 mol %). In contrast, the scandium-based system Sc-3 with a sterically more crowded ligand framework demonstrated the activities at 285 and 252 kg_{polymer}/mol_{Ln} upon activation with DIMAH-D4/DIBAL and MAO, respectively (runs 7 and 8). Moreover, the catalyst Sc-3 is tolerant to conjugated dienes and affords the incorporation of 50 mol % of butadiene into the polymeric product. In contrast, much less activity and lower incorporation of BD were observed for the Y-analog (Y-3) activated by the borate (run 9). The activation of Y-3 by MAO resulted in the formation of a gel as a main product. The bisphenolate catalysts with the amido auxiliary ligand do not show a high activity except the Sc-complex Sc-3-N(runs 11-18). Nevertheless, the activity of Sc-3-N(runs 11 and 12) remains lower compared to its alkyl analog Sc-3 (runs 7 and 8) despite the virtually identical polymerization mechanism.

TABLE 3
Polymerization data for bis(phenolate)-catalysts.*

| | | | | | BD (vinyl/1,4- | | |
|---|---|---|---|---|---|---|---|
| | | | | | trans/1,4- | | |
| | | | Yield | Activity | cis), cC5** | M_{w} | |
| run | Catalyst | Activator | (g) | (kg/mol_{Ln}) | mol % | (kDa) | PDI |
| 1 | Y-1 | DIMAH-D4/DIBAL | 0 | 0 | — | — | — |
| 2 | Y-1 | MAO | 0.04 | 43 | 0.4 (vinyl), 0.7 (1,4) | 162.819 | 2.93 |
| 3 | Sc-2 | DIMAH-D4/DIBAL | 0 | 0 | — | — | — |
| 4 | Sc-2 | MAO | 0.023 | 25 | | 122.760 | 2.76 |
| 5 | Y-2 | DIMAH-D4/DIBAL | 0 | 0 | — | — | — |
| 6 | Y-2 | MAO | 0.01 | 11 | 0.2 (vinyl), 0.4 (1,4) | | |
| 7 | Sc-3 | DIMAH-D4/DIBAL | 1.31 | 285 | (3/5/19), 0 | 306 | 65.6 |
| 8 | Sc-3 | MAO | 1.16 | 252 | (1/8/2), 7 | (mainly gel) | |
| 9 | Y-3 | DIMAH-D4/DIBAL | 0.104 | 23 | 0.3 (vinyl), 0.7 (1,4) | 222 | 4.10 |
| 10 | Y-3 | MAO | 0.855 | 186 | (1/0/1), 5 | (mainly gel) | |
| 11 | Sc-3-N | DIMAH-D4/DIBAL | 0.210 | 46 | (3/3/20), 0.4 | 371 | 16.92 |
| 12 | Sc-3-N | MAO | 0.622 | 135 | Cross-linked | | |
| 13 | Y-3-N | DIMAH-D4/DIBAL | 0.020 | 4 | | | |
| 14 | Y-3-N | MAO | 0.045 | 10 | 0.6 (vinyl), 1.8 (1,4) | (mainly gel) | |
| 15 | La-3-N | DIMAH-D4/DIBAL | 0.02 | 4 | | | |
| 16 | La-3-N | MAO | 0.068 | 15 | cross-linked | | |
| 17 | Nd-3-N | DIMAH-D4/DIBAL | 0.036 | 8 | | | |
| 18 | Nd-3-N | MAO | 0.063 | 14 | 0.9 (vinyl), 3.5 (1,4) | | |

*Conditions: ca 1 g BD, toluene solution, BD:Catalyst = 2500:1; 250 psi ethylene; 100° C.; 14 h; 1.5 eq DIMAH-D4/44 eq DIBAL or 100 eq MAO.
**1,2-trans-cyclopentane.

### Example 18—Effects of Activator Content

The role of various equivalents of DIBAL on catalyst activity, composition and molecular weight of the product, was investigated in detail for copolymerization reactions induced by the scandium bis(phenolate)-catalyst Sc-3. The catalyst activity substantially grows up upon increasing the DIBAL concentration from 20 eq. to 60 eq. (66.8 to 263.5 kg_{polymer}/mol_{Sc}) and then, slightly drops down at 80 eq. of DIBAL (204.1 kg_{polymer}/mol_{Sc}, Table 4). The higher concentrations of DIBAL leads to lower M_{w}'s of the polymer products, thus allowing accurate controlling the M_{w}'s in the polymerization process. This observation is consistent with the coordinative chain transfer mechanism of copolymerization. The products show broad molecular weight distribution ranging from 10.8 to 52.34. The melting peaks at Tₘ=112-128° C., observed in the DSC's of the obtained polymers indicate the presence of PE-enriched blocks.

TABLE 4
Polymerization data for Sc-3 in the presence of various equivalents of DIBAL.*

| | Activity | | BD (vinyl/1,4- | | | |
|---|---|---|---|---|---|---|
| | (kg_{polymer}/ | C2, | trans/1,4-cis), | M_{w}, | | |
| DIBAL:Sc | mol_{Sc}) | mol % | cC5** mol % | kDa | PDI | DSC |
| 20 | 66.8 | 50 | (4/8/38), 0.2 | 498 | 52.34 | Tₘ 128 & 112° C., T_{g} −104° C. |
| 40 | 206.7 | 70 | (2/5/22), 0.2 | 354 | 29.93 | Tₘ 124° C., T_{g} −104° C. |
| 60 | 263.5 | 77 | (2/5/17), 0.1 | 255 | 37.09 | Tₘ 123° C., −104° C. |
| 80 | 204.1 | 62 | (3/6/28), 0.1 | 302 | 10.79 | Tₘ 124° C., −104° C. |

*Conditions: ca 1 g BD, toluene solution, BD:Sc-3 = 2500:1; 250 psi ethylene; 100° C.; 14 hours; 1.5 eq. DIMAH-D4.
**1,2-trans-cyclopentane.

Interestingly, the catalyst Sc-3 can be used for homopolymerization of ethylene when activated with DIBAL only (runs 1 and 2, Table 5). The presence of the borate activator significantly reduces the activity for ethylene polymerization. In contrast to homopolymerization with ethylene and C₂/C₄ copolymerization, catalyst Sc-3 does not show any noticeable activity for homopolymerization of butadiene in the presence of different activators (runs 7-12).

TABLE 5
Activity of Sc-3 for homopolymerization of ethylene or butadiene.*

| | | | | Activity |
|---|---|---|---|---|
| Run | Monomer | Activator | Time, h | (kg_{polymer}/mol_{Sc}) |
| 1 | C₂ | DIBAL, 40 eq. | 3 | 304.4 |
| 2 | C₂ | DIBAL, 20 eq. | 3 | 266.3 |
| 3 | C₂ | DIMAH-D4, | 3 | 0 |
| | | 1.5 eq. | | |
| 4 | C₂ | DIMAH- | 3 | 117.9 |
| | | D4/DIBAL, | | |
| | | 1.5/40 eq.) | | |
| 5 | C₂ | DIMAH- | 3 | 90.1 |
| | | D4/DIBAL | | |
| | | 1.1/20 eq. | | |
| 6 | C₂ | MAO, 100 eq. | 3 | 101.0 |
| 7 | BD | DIBAL, 40 eq. | 3 | 2.2 |
| 8 | BD | DIBAL, 20 eq. | 3 | 0 |
| 9 | BD | DIMAH-D4, | 3 | 0 |
| | | 1.5 eq. | | |
| 10 | BD | DIMAH- | 3 | 0 |
| | | D4/DIBAL, | | |
| | | 1.5/40 eq. | | |
| 11 | BD | DIMAH- | 3 | 0 |
| | | D4/DIBAL | | |
| | | 1.1/20 eq. | | |
| 12 | BD | MAO, 100 eq. | 16 | 10.9 |

*Conditions: ca 1 g BD, toluene solution, BD:Sc-3 = 2500:1; 250 psi ethylene; 100° C.

### High-throughput Polymerization Examples for Alkene Homo- and Copolymerization

Solutions of the pre-catalysts were made using toluene (ExxonMobil Chemical anhydrous, stored under N₂) (98%). Pre-catalyst solutions were typically 0.5 mmol/L.

Solvents, polymerization grade toluene and/or isohexanes were supplied by ExxonMobil Chemical Co. and are purified by passing through a series of columns: two 500 cc Oxyclear cylinders in series from Labclear (Oakland, Calif), followed by two 500 cc columns in series packed with dried 3 Å mole sieves (8-12 mesh; Aldrich Chemical Company), and two 500 cc columns in series packed with dried 5 Å mole sieves (8-12 mesh; Aldrich Chemical Company).

### Preparation of Dried Heated Methylaluminoxane (DHMAO).

In a drybox, to a 1 liter flask equipted with a Kontes closure and side arm, 500 ml of methylaluminoxane (Albemarle, 30 wt % in toluene) was added. The flask was then transferred and attached to a Schlenk line. The toluene and volatile trimethylaluminum was removed in vacuo and collected in a liquid nitrogen cooled trap. After approximately 4 hours, only solids remained. At this point, the flask was heated to 70° C. under vacuum for 8 hours to remove residual solvent and additional trimethylaluminum. The flask was then placed under nitrogen, and allowed to cool to room temperature, after which it was transferred to a drybox to mix the caked solids. The flask was returned to the Schlenk line and again heated to 70° C. under vacuum for an additional 6 hours. The flask was then placed under nitrogen, and allowed to cool to room temperature, after which it was transferred back to a drybox where 142.3 g of white solid was recovered.

1-octene (C₈; 98%, Aldrich Chemical Company) was dried by stirring over NaK overnight followed by filtration through basic alumina (Aldrich Chemical Company, Brockman Basic 1).

Polymerization grade ethylene (C₂) was used and further purified by passing it through a series of columns: 500 cc Oxyclear cylinder from Labclear (Oakland, Calif.) followed by a 500 cc column packed with dried 3 Å mole sieves (8-12 mesh; Aldrich Chemical Company), and a 500 cc column packed with dried 5 Å mole sieves (8-12 mesh; Aldrich Chemical Company).

Various scavengers were used including tri-n-octylaluminum (TNOAL, Neat, AkzoNobel), tri-isobutylaluminum (TIBAL, Neat, Aldrich), dried heated MAO (DHMAO, as prepared above). Scavengers were typically used as a 5.0 mmol/L solution in toluene. Scavengers can also be referred to as activators and/or chain transfer agents.

### Reactor Description and Preparation:

Polymerizations were conducted in an inert atmosphere (N₂) drybox using autoclaves equipped with an external heater for temperature control, glass inserts (internal volume of reactor=23.5 mL for C₂ and C₂/C₈), septum inlets, regulated supply of nitrogen, ethylene and propylene, and equipped with disposable PEEK mechanical stirrers (800 RPM). The autoclaves were prepared by purging with dry nitrogen at 110° C. or 115° C. for 5 hours and then at 25° C. for 5 hours.

### Ethylene Polymerization (PE) or Ethylene/1-Octene Copolymerization (EO):

The reactor was prepared as described above, and then purged with ethylene. Toluene (5.0 ml for PE runs and 4.9 ml for EO runs) and 1-octene (100 μL when used) were added via syringe at room temperature and atmospheric pressure. The reactor was then brought to process temperature (80° C., 100° C. or 110° C.) and charged with ethylene to process pressure (75 psig=618.5 kPa) while stirring at 800 RPM. The scavenger solution, followed by the catalyst solution, were injected via syringe to the reactor at process conditions. Ethylene was allowed to enter (through the use of computer controlled solenoid valves) the autoclaves during polymerization to maintain reactor gauge pressure (+/−2 psig). Reactor temperature was monitored and typically maintained within +/−1° C. Polymerizations were halted by addition of approximately 50 psi compressed dry air gas mixture or 100% CO₂ gas to the autoclave for approximately 30 seconds. The polymerizations were quenched after a predetermined cumulative amount of ethylene had been added (maximum quench value of 20 psid) or for a maximum of 30 minutes polymerization time. Afterwards, the reactors were cooled and vented. Polymers were isolated after the solvent was removed in-vacuo. Yields reported include total weight of polymer and residual catalyst. Catalyst activity is reported as grams of polymer per mmol transition or lanthanide metal compound per hour of reaction time (g/mmol·hr). Polymerization runs are summarized in Table 6.

### Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (M_{w}) and number average molecular weight (Mn)) and molecular weight distribution (MWD=M_{w}/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 m Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Table 6 under the headings Mn, Mw and PDI as defined above.

Differential Scanning Calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Table 6 under the heading, Tm (° C.).

Samples for infrared analysis were prepared by depositing the stabilized polymer solution onto a silanized wafer (Part number S10860, Symyx). By this method, approximately between 0.12 mg and 0.24 mg of polymer is deposited on the wafer cell. The samples were subsequently analyzed on a Brucker Equinox 55 FTIR spectrometer equipped with Pikes' MappIR specular reflectance sample accessory. Spectra, covering a spectral range of 5000 cm⁻¹ to 500 cm⁻¹, were collected at a 2 cm⁻¹ resolution with 32 scans.

For ethylene-1-octene copolymers, the wt % octene in the copolymer was determined via measurement of the methyl deformation band at ~1375 cm⁻¹. The peak height of this band was normalized by the combination and overtone band at ~4321 cm⁻¹, which corrects for path length differences. The normalized peak height was correlated to individual calibration curves from ¹H NMR data to predict the wt % octene content within a concentration range of ~2 to 35 wt % for octene. Typically, R² correlations of 0.98 or greater are achieved. These numbers are reported in Table 6 under the heading C₈ wt %).

Polymerization results are collected in Table 6 below. “Ex #” stands for example number. “Cat” identifies the catalyst/complex used in the experiment. Corresponding numbers identifying the pre-catalyst (also referred to as pre-catalyst, complex or compound) are located in the synthetic experimental section. “Cat (μmol)” is the amount of catalyst added to the reactor. “Scav” is identifies the scavenger used. “Scav (μmol)” os the amount of scavenger/activator used, and “Scav/Cat (molar)” is the molar ratio of scavenger/activator to catalyst used. “C₈ (μl)” is the amount of 1-octene used. T(° C.) is the polymerization temperature which was typically maintained within +/−1° C. “Yield” is polymer yield, and is not corrected for catalyst residue. “Quench time (s)” is the actual duration of the polymerization run in seconds. “Quench Value (psid)” for ethylene based polymerization runs is the set maximum amount of ethylene uptake (conversion) for the experiment. If a polymerization quench time is less than the maximum time set, then the polymerization ran until the set maximum value of ethylene uptake was reached.

TABLE 6
Ethylene homopolymerizations and Ethylene-1-octene copolymerization examples

| | | Cat | | Scav | Scav/Cat | C8 | | quench | yield |
|---|---|---|---|---|---|---|---|---|---|
| Ex# | Cat | (μmol) | Scav | (μmol) | (molar) | (μl) | T(C) | time (s) | (g) |
| s-1 | Sc-1 | 0.040 | DHMAO | 1 | 25.0 | 100 | 80 | 376 | 0.0801 |
| s-2 | Sc-1 | 0.040 | DHMAO | 1 | 25.0 | 100 | 100 | 1800 | 0.0139 |
| s-3 | Sc-1 | 0.040 | TIBAL | 0.25 | 6.3 | 100 | 80 | 162 | 0.0732 |
| s-4 | Sc-1 | 0.040 | TIBAL | 0.5 | 12.5 | 100 | 80 | 94 | 0.0417 |
| s-5 | Sc-1 | 0.040 | TIBAL | 1 | 25.0 | 100 | 80 | 207 | 0.0305 |
| s-6 | Sc-1 | 0.040 | TIBAL | 0.25 | 6.3 | 100 | 100 | 104 | 0.0400 |
| s-7 | Sc-1 | 0.040 | TIBAL | 0.5 | 12.5 | 100 | 100 | 1801 | 0.0210 |
| s-8 | Sc-1 | 0.040 | TIBAL | 1 | 25.0 | 100 | 100 | 1800 | 0.0212 |
| s-9 | Sc-1 | 0.040 | TNOAL | 0.25 | 6.3 | 100 | 80 | 373 | 0.0822 |
| s-10 | Sc-1 | 0.040 | TNOAL | 0.5 | 12.5 | 100 | 80 | 147 | 0.0404 |
| s-11 | Sc-1 | 0.040 | TNOAL | 1 | 25.0 | 100 | 80 | 531 | 0.0284 |
| s-12 | Sc-1 | 0.040 | TNOAL | 0.25 | 6.3 | 100 | 100 | 92 | 0.0550 |
| s-13 | Sc-1 | 0.040 | TNOAL | 0.5 | 12.5 | 100 | 100 | 63 | 0.0500 |
| s-14 | Sc-1 | 0.040 | TNOAL | 1 | 25.0 | 100 | 100 | 1800 | 0.0008 |
| s-15 | Sc-1 | 0.040 | DHMAO | 1 | 25.0 | 0 | 80 | 297 | 0.0613 |
| s-16 | Sc-1 | 0.040 | DHMAO | 1 | 25.0 | 0 | 80 | 131 | 0.0763 |
| s-17 | Sc-1 | 0.040 | DHMAO | 1 | 25.0 | 0 | 100 | 1800 | 0.0135 |
| s-18 | Sc-1 | 0.040 | DHMAO | 1 | 25.0 | 0 | 100 | 1802 | 0.0091 |
| s-19 | Sc-1 | 0.040 | TIBAL | 0.25 | 6.3 | 0 | 80 | 130 | 0.0735 |
| s-20 | Sc-1 | 0.040 | TIBAL | 0.25 | 6.3 | 0 | 80 | 344 | 0.0860 |
| s-21 | Sc-1 | 0.040 | TIBAL | 0.5 | 12.5 | 0 | 80 | 151 | 0.0305 |
| s-22 | Sc-1 | 0.040 | TIBAL | 0.5 | 12.5 | 0 | 80 | 98 | 0.0429 |
| s-23 | Sc-1 | 0.040 | TIBAL | 1 | 25.0 | 0 | 80 | 382 | 0.0256 |
| s-24 | Sc-1 | 0.040 | TIBAL | 1 | 25.0 | 0 | 80 | 409 | 0.0276 |
| s-25 | Sc-1 | 0.040 | TIBAL | 0.25 | 6.3 | 0 | 100 | 1800 | 0.0112 |
| s-26 | Sc-1 | 0.040 | TIBAL | 0.25 | 6.3 | 0 | 100 | 190 | 0.0658 |
| s-27 | Sc-1 | 0.040 | TIBAL | 0.5 | 12.5 | 0 | 100 | 46 | 0.0522 |
| s-28 | Sc-1 | 0.040 | TIBAL | 0.5 | 12.5 | 0 | 100 | 56 | 0.0542 |
| s-29 | Sc-1 | 0.040 | TIBAL | 1 | 25.0 | 0 | 100 | 137 | 0.0332 |
| s-30 | Sc-1 | 0.040 | TIBAL | 1 | 25.0 | 0 | 100 | 97 | 0.0364 |
| s-31 | Sc-1 | 0.040 | TNOAL | 0.25 | 6.3 | 0 | 80 | 236 | 0.0809 |
| s-32 | Sc-1 | 0.040 | TNOAL | 0.25 | 6.3 | 0 | 80 | 274 | 0.0835 |
| s-33 | Sc-1 | 0.040 | TNOAL | 0.5 | 12.5 | 0 | 80 | 109 | 0.0409 |
| s-34 | Sc-1 | 0.040 | TNOAL | 0.5 | 12.5 | 0 | 80 | 129 | 0.0418 |
| s-35 | Sc-1 | 0.040 | TNOAL | 1 | 25.0 | 0 | 80 | 267 | 0.0325 |
| s-36 | Sc-1 | 0.040 | TNOAL | 1 | 25.0 | 0 | 80 | 408 | 0.0309 |
| s-37 | Sc-1 | 0.040 | TNOAL | 0.25 | 6.3 | 0 | 100 | 249 | 0.0604 |
| s-38 | Sc-1 | 0.040 | TNOAL | 0.25 | 6.3 | 0 | 100 | 261 | 0.0615 |
| s-39 | Sc-1 | 0.040 | TNOAL | 0.5 | 12.5 | 0 | 100 | 50 | 0.0588 |
| s-40 | Sc-1 | 0.040 | TNOAL | 0.5 | 12.5 | 0 | 100 | 55 | 0.0556 |
| s-41 | Sc-1 | 0.040 | TNOAL | 1 | 25.0 | 0 | 100 | 752 | 0.0269 |
| s-42 | Sc-1 | 0.040 | TNOAL | 1 | 25.0 | 0 | 100 | 107 | 0.0367 |
| s-43 | Sc-2 | 0.040 | DHMAO | 1 | 25.0 | 100 | 80 | 318 | 0.0595 |
| s-44 | Sc-2 | 0.040 | DHMAO | 1 | 25.0 | 100 | 100 | 136 | 0.0462 |
| s-45 | Sc-2 | 0.040 | TIBAL | 0.25 | 6.3 | 100 | 80 | 99 | 0.0448 |
| s-46 | Sc-2 | 0.040 | TIBAL | 0.5 | 12.5 | 100 | 80 | 145 | 0.0366 |
| s-47 | Sc-2 | 0.040 | TIBAL | 1 | 25.0 | 100 | 80 | 233 | 0.0309 |
| s-48 | Sc-2 | 0.040 | TIBAL | 0.25 | 6.3 | 100 | 100 | 58 | 0.0550 |
| s-49 | Sc-2 | 0.040 | TIBAL | 0.5 | 12.5 | 100 | 100 | 111 | 0.0412 |
| s-50 | Sc-2 | 0.040 | TIBAL | 1 | 25.0 | 100 | 100 | 125 | 0.0413 |
| s-51 | Sc-2 | 0.040 | TNOAL | 0.25 | 6.3 | 100 | 80 | 114 | 0.0441 |
| s-52 | Sc-2 | 0.040 | TNOAL | 0.5 | 12.5 | 100 | 80 | 225 | 0.0088 |
| s-53 | Sc-2 | 0.040 | TNOAL | 1 | 25.0 | 100 | 80 | 517 | 0.0311 |
| s-54 | Sc-2 | 0.040 | TNOAL | 0.25 | 6.3 | 100 | 100 | 96 | 0.0403 |
| s-55 | Sc-2 | 0.040 | TNOAL | 0.5 | 12.5 | 100 | 100 | 76 | 0.0476 |
| s-56 | Sc-2 | 0.040 | TNOAL | 1 | 25.0 | 100 | 100 | 97 | 0.0452 |
| s-57 | Sc-2 | 0.040 | DHMAO | 1 | 25.0 | 0 | 80 | 240 | 0.0675 |
| s-58 | Sc-2 | 0.040 | DHMAO | 1 | 25.0 | 0 | 80 | 184 | 0.0602 |
| s-59 | Sc-2 | 0.040 | DHMAO | 1 | 25.0 | 0 | 100 | 377 | 0.0633 |
| s-60 | Sc-2 | 0.040 | DHMAO | 1 | 25.0 | 0 | 100 | 283 | 0.0677 |
| s-61 | Sc-2 | 0.040 | TIBAL | 0.25 | 6.3 | 0 | 80 | 102 | 0.0440 |
| s-62 | Sc-2 | 0.040 | TIBAL | 0.25 | 6.3 | 0 | 80 | 121 | 0.0530 |
| s-63 | Sc-2 | 0.040 | TIBAL | 0.5 | 12.5 | 0 | 80 | 221 | 0.0351 |
| s-64 | Sc-2 | 0.040 | TIBAL | 0.5 | 12.5 | 0 | 80 | 170 | 0.0349 |
| s-65 | Sc-2 | 0.040 | TIBAL | 1 | 25.0 | 0 | 80 | 298 | 0.0278 |
| s-66 | Sc-2 | 0.040 | TIBAL | 1 | 25.0 | 0 | 80 | 366 | 0.0283 |
| s-67 | Sc-2 | 0.040 | TIBAL | 0.25 | 6.3 | 0 | 100 | 1801 | −0.0008 |
| s-68 | Sc-2 | 0.040 | TIBAL | 0.25 | 6.3 | 0 | 100 | 67 | 0.0521 |
| s-69 | Sc-2 | 0.040 | TIBAL | 0.5 | 12.5 | 0 | 100 | 72 | 0.0449 |
| s-70 | Sc-2 | 0.040 | TIBAL | 0.5 | 12.5 | 0 | 100 | 73 | 0.0451 |
| s-71 | Sc-2 | 0.040 | TIBAL | 1 | 25.0 | 0 | 100 | 120 | 0.0381 |
| s-72 | Sc-2 | 0.040 | TIBAL | 1 | 25.0 | 0 | 100 | 108 | 0.0385 |
| s-73 | Sc-2 | 0.040 | TNOAL | 0.25 | 6.3 | 0 | 80 | 105 | 0.0477 |
| s-74 | Sc-2 | 0.040 | TNOAL | 0.25 | 6.3 | 0 | 80 | 115 | 0.0441 |
| s-75 | Sc-2 | 0.040 | TNOAL | 0.5 | 12.5 | 0 | 80 | 159 | 0.0342 |
| s-76 | Sc-2 | 0.040 | TNOAL | 0.5 | 12.5 | 0 | 80 | 218 | 0.0257 |
| s-77 | Sc-2 | 0.040 | TNOAL | 1 | 25.0 | 0 | 80 | 254 | 0.0318 |
| s-78 | Sc-2 | 0.040 | TNOAL | 1 | 25.0 | 0 | 80 | 410 | 0.0303 |
| s-79 | Sc-2 | 0.040 | TNOAL | 0.25 | 6.3 | 0 | 100 | 86 | 0.0421 |
| s-80 | Sc-2 | 0.040 | TNOAL | 0.25 | 6.3 | 0 | 100 | 71 | 0.0508 |
| s-81 | Sc-2 | 0.040 | TNOAL | 0.5 | 12.5 | 0 | 100 | 78 | 0.0486 |
| s-82 | Sc-2 | 0.040 | TNOAL | 0.5 | 12.5 | 0 | 100 | 68 | 0.0469 |
| s-83 | Sc-2 | 0.040 | TNOAL | 1 | 25.0 | 0 | 100 | 121 | 0.0386 |
| s-84 | Sc-2 | 0.040 | TNOAL | 1 | 25.0 | 0 | 100 | 107 | 0.0388 |
| s-85 | Sc-3 | 0.040 | DHMAO | 0.50 | 12.5 | 100 | 80 | 528 | 0.0470 |
| s-86 | Sc-3 | 0.040 | DHMAO | 1.00 | 25.0 | 100 | 80 | 253 | 0.0823 |
| s-87 | Sc-3 | 0.040 | DHMAO | 0.50 | 12.5 | 100 | 100 | 1800 | 0.0062 |
| s-88 | Sc-3 | 0.040 | DHMAO | 1.00 | 25.0 | 100 | 100 | 141 | 0.0330 |
| s-89 | Sc-3 | 0.040 | TIBAL | 0.50 | 12.5 | 100 | 80 | 84 | 0.0370 |
| s-90 | Sc-3 | 0.040 | TIBAL | 0.50 | 12.5 | 100 | 100 | 67 | 0.0411 |
| s-91 | Sc-3 | 0.040 | TNOAL | 0.50 | 12.5 | 100 | 80 | 152 | 0.0353 |
| s-92 | Sc-3 | 0.040 | TNOAL | 1.00 | 25.0 | 100 | 80 | 370 | 0.0318 |
| s-93 | Sc-3 | 0.040 | TNOAL | 0.50 | 12.5 | 100 | 100 | 105 | 0.0356 |
| s-94 | Sc-3 | 0.040 | TNOAL | 1.00 | 25.0 | 100 | 100 | 431 | 0.0305 |
| s-95 | Sc-3 | 0.040 | DHMAO | 0.50 | 12.5 | 0 | 80 | 435 | 0.0574 |
| s-96 | Sc-3 | 0.040 | DHMAO | 0.50 | 12.5 | 0 | 80 | 514 | 0.0457 |
| s-97 | Sc-3 | 0.040 | DHMAO | 1.00 | 25.0 | 0 | 80 | 917 | 0.0400 |
| s-98 | Sc-3 | 0.040 | DHMAO | 1.00 | 25.0 | 0 | 80 | 609 | 0.0487 |
| s-99 | Sc-3 | 0.040 | DHMAO | 0.50 | 12.5 | 0 | 100 | 1801 | 0.0026 |
| s-100 | Sc-3 | 0.040 | DHMAO | 0.50 | 12.5 | 0 | 100 | 1800 | 0.0056 |
| s-101 | Sc-3 | 0.040 | DHMAO | 1.00 | 25.0 | 0 | 100 | 1691 | 0.0191 |
| s-102 | Sc-3 | 0.040 | DHMAO | 1.00 | 25.0 | 0 | 100 | 298 | 0.0312 |
| s-103 | Sc-3 | 0.040 | TIBAL | 0.50 | 12.5 | 0 | 80 | 86 | 0.0379 |
| s-104 | Sc-3 | 0.040 | TIBAL | 0.50 | 12.5 | 0 | 80 | 93 | 0.0335 |
| s-105 | Sc-3 | 0.040 | TIBAL | 0.50 | 12.5 | 0 | 100 | 69 | 0.0373 |
| s-106 | Sc-3 | 0.040 | TIBAL | 0.50 | 12.5 | 0 | 100 | 64 | 0.0392 |
| s-107 | Sc-3 | 0.040 | TNOAL | 0.50 | 12.5 | 0 | 80 | 132 | 0.0382 |
| s-108 | Sc-3 | 0.040 | TNOAL | 0.50 | 12.5 | 0 | 80 | 119 | 0.0431 |
| s-109 | Sc-3 | 0.040 | TNOAL | 1.00 | 25.0 | 0 | 80 | 358 | 0.0306 |
| s-110 | Sc-3 | 0.040 | TNOAL | 1.00 | 25.0 | 0 | 80 | 175 | 0.0285 |
| s-111 | Sc-3 | 0.040 | TNOAL | 0.50 | 12.5 | 0 | 100 | 67 | 0.0474 |
| s-112 | Sc-3 | 0.040 | TNOAL | 0.50 | 12.5 | 0 | 100 | 67 | 0.0441 |
| s-113 | Sc-3 | 0.040 | TNOAL | 1.00 | 25.0 | 0 | 100 | 174 | 0.0302 |
| s-114 | Sc-3 | 0.040 | TNOAL | 1.00 | 25.0 | 0 | 100 | 213 | 0.0302 |
| s-115 | Lu-3 | 0.040 | TIBAL | 0.5 | 12.5 | 100 | 80 | 1801 | 0.0029 |
| s-116 | Lu-3 | 0.040 | TIBAL | 0.5 | 12.5 | 100 | 80 | 1801 | 0.0026 |
| s-117 | Lu-3 | 0.040 | TIBAL | 0.5 | 12.5 | 100 | 80 | 1801 | 0.0028 |
| s-118 | Lu-3 | 0.040 | TIBAL | 0.5 | 12.5 | 400 | 80 | 1801 | 0.0030 |
| s-119 | Lu-3 | 0.040 | TIBAL | 0.5 | 12.5 | 400 | 80 | 1800 | 0.0027 |
| s-120 | Lu-3 | 0.040 | TIBAL | 0.5 | 12.5 | 400 | 80 | 1802 | 0.0026 |
| s-121 | Lu-3 | 0.040 | TIBAL | 0.5 | 12.5 | 100 | 100 | 1801 | 0.0100 |
| s-122 | Lu-3 | 0.040 | TIBAL | 0.5 | 12.5 | 100 | 100 | 1801 | 0.0100 |
| s-123 | Lu-3 | 0.040 | TIBAL | 0.5 | 12.5 | 100 | 100 | 1801 | 0.0097 |
| s-124 | Lu-3 | 0.040 | TIBAL | 0.5 | 12.5 | 400 | 100 | 1802 | 0.0102 |
| s-125 | Lu-3 | 0.040 | TIBAL | 0.5 | 12.5 | 400 | 100 | 1800 | 0.0100 |
| s-126 | Lu-3 | 0.040 | TIBAL | 0.5 | 12.5 | 400 | 100 | 1801 | 0.0092 |
| s-127 | Lu-3 | 0.040 | TIBAL | 0.5 | 12.5 | 0 | 80 | 1800 | 0.0032 |
| s-128 | Lu-3 | 0.040 | TIBAL | 0.5 | 12.5 | 0 | 80 | 1800 | 0.0027 |
| s-129 | Lu-3 | 0.040 | TIBAL | 0.5 | 12.5 | 0 | 80 | 1801 | 0.0024 |
| s-130 | Lu-3 | 0.040 | TIBAL | 0.5 | 12.5 | 0 | 100 | 1800 | 0.0105 |
| s-131 | Lu-3 | 0.040 | TIBAL | 0.5 | 12.5 | 0 | 100 | 1801 | 0.0094 |
| s-132 | Lu-3 | 0.040 | TIBAL | 0.5 | 12.5 | 0 | 100 | 1801 | 0.0095 |
| s-133 | Y-1 | 0.060 | DHMAO | 1 | 16.7 | 100 | 80 | 1801 | −0.0004 |
| s-134 | Y-1 | 0.060 | DHMAO | 1 | 16.7 | 100 | 100 | 1801 | 0.0002 |
| s-135 | Y-1 | 0.060 | DHMAO | 1 | 16.7 | 100 | 110 | 1801 | 0.0016 |
| s-136 | Y-1 | 0.060 | TIBAL | 0.25 | 4.2 | 100 | 80 | 1800 | −0.0004 |
| s-137 | Y-1 | 0.060 | TIBAL | 0.5 | 8.3 | 100 | 80 | 1801 | −0.0003 |
| s-138 | Y-1 | 0.060 | TIBAL | 1 | 16.7 | 100 | 80 | 1801 | −0.0006 |
| s-139 | Y-1 | 0.060 | TIBAL | 0.25 | 4.2 | 100 | 100 | 1801 | 0.0003 |
| s-140 | Y-1 | 0.060 | TIBAL | 0.5 | 8.3 | 100 | 100 | 1800 | 0.0008 |
| s-141 | Y-1 | 0.060 | TIBAL | 1 | 16.7 | 100 | 100 | 1800 | 0.0002 |
| s-142 | Y-1 | 0.060 | TIBAL | 0.25 | 4.2 | 100 | 110 | 1800 | 0.0014 |
| s-143 | Y-1 | 0.060 | TIBAL | 0.5 | 8.3 | 100 | 110 | 1801 | 0.0012 |
| s-144 | Y-1 | 0.060 | TIBAL | 1 | 16.7 | 100 | 110 | 1800 | 0.0012 |
| s-145 | Y-1 | 0.060 | TNOAL | 0.25 | 4.2 | 100 | 80 | 1801 | −0.0004 |
| s-146 | Y-1 | 0.060 | TNOAL | 0.5 | 8.3 | 100 | 80 | 1801 | −0.0005 |
| s-147 | Y-1 | 0.060 | TNOAL | 1 | 16.7 | 100 | 80 | 1802 | −0.0005 |
| s-148 | Y-1 | 0.060 | TNOAL | 0.25 | 4.2 | 100 | 100 | 1800 | 0.0004 |
| s-149 | Y-1 | 0.060 | TNOAL | 0.5 | 8.3 | 100 | 100 | 1800 | 0.0000 |
| s-150 | Y-1 | 0.060 | TNOAL | 1 | 16.7 | 100 | 100 | 1800 | 0.0001 |
| s-151 | Y-1 | 0.060 | TNOAL | 0.25 | 4.2 | 100 | 110 | 1801 | 0.0016 |
| s-152 | Y-1 | 0.060 | TNOAL | 0.5 | 8.3 | 100 | 110 | 1801 | 0.0010 |
| s-153 | Y-1 | 0.060 | TNOAL | 1 | 16.7 | 100 | 110 | 1800 | 0.0018 |
| s-154 | Y-1 | 0.060 | DHMAO | 1 | 16.7 | 0 | 80 | 1802 | 0.0002 |
| s-155 | Y-1 | 0.060 | DHMAO | 1 | 16.7 | 0 | 100 | 1800 | 0.0004 |
| s-156 | Y-1 | 0.060 | DHMAO | 1 | 16.7 | 0 | 110 | 1800 | 0.0017 |
| s-157 | Y-1 | 0.060 | TIBAL | 0.25 | 4.2 | 0 | 80 | 1801 | 0.0001 |
| s-158 | Y-1 | 0.060 | TIBAL | 0.5 | 8.3 | 0 | 80 | 1802 | −0.0006 |
| s-159 | Y-1 | 0.060 | TIBAL | 1 | 16.7 | 0 | 80 | 1800 | −0.0006 |
| s-160 | Y-1 | 0.060 | TIBAL | 0.25 | 4.2 | 0 | 100 | 1801 | 0.0045 |
| s-161 | Y-1 | 0.060 | TIBAL | 0.5 | 8.3 | 0 | 100 | 1800 | 0.0009 |
| s-162 | Y-1 | 0.060 | TIBAL | 1 | 16.7 | 0 | 100 | 1800 | 0.0004 |
| s-163 | Y-1 | 0.060 | TIBAL | 0.25 | 4.2 | 0 | 110 | 1800 | 0.0017 |
| s-164 | Y-1 | 0.060 | TIBAL | 0.5 | 8.3 | 0 | 110 | 1800 | 0.0015 |
| s-165 | Y-1 | 0.060 | TIBAL | 1 | 16.7 | 0 | 110 | 1801 | 0.0019 |
| s-166 | Y-1 | 0.060 | TNOAL | 0.25 | 4.2 | 0 | 80 | 1801 | −0.0003 |
| s-167 | Y-1 | 0.060 | TNOAL | 0.5 | 8.3 | 0 | 80 | 1800 | −0.0005 |
| s-168 | Y-1 | 0.060 | TNOAL | 1 | 16.7 | 0 | 80 | 1801 | −0.0006 |
| s-169 | Y-1 | 0.060 | TNOAL | 0.25 | 4.2 | 0 | 100 | 1800 | 0.0006 |
| s-170 | Y-1 | 0.060 | TNOAL | 0.5 | 8.3 | 0 | 100 | 1801 | 0.0005 |
| s-171 | Y-1 | 0.060 | TNOAL | 1 | 16.7 | 0 | 100 | 1800 | 0.0004 |
| s-172 | Y-1 | 0.060 | TNOAL | 0.25 | 4.2 | 0 | 110 | 1801 | 0.0014 |
| s-173 | Y-1 | 0.060 | TNOAL | 0.5 | 8.3 | 0 | 110 | 1801 | 0.0014 |
| s-174 | Y-1 | 0.060 | TNOAL | 1 | 16.7 | 0 | 110 | 1801 | 0.0017 |
| s-175 | Y-3 | 0.040 | TIBAL | 0.5 | 12.5 | 100 | 80 | 1801 | 0.0025 |
| s-176 | Y-3 | 0.040 | TIBAL | 0.5 | 12.5 | 100 | 80 | 1800 | 0.0022 |
| s-177 | Y-3 | 0.040 | TIBAL | 0.5 | 12.5 | 100 | 80 | 1801 | 0.0022 |
| s-178 | Y-3 | 0.040 | TIBAL | 0.5 | 12.5 | 100 | 80 | 1800 | 0.0020 |
| s-179 | Y-3 | 0.040 | TIBAL | 0.5 | 12.5 | 400 | 80 | 1801 | 0.0022 |
| s-180 | Y-3 | 0.040 | TIBAL | 0.5 | 12.5 | 400 | 80 | 1801 | 0.0020 |
| s-181 | Y-3 | 0.040 | TIBAL | 0.5 | 12.5 | 400 | 80 | 1800 | 0.0019 |
| s-182 | Y-3 | 0.040 | TIBAL | 0.5 | 12.5 | 400 | 80 | 1800 | 0.0020 |
| s-183 | Y-3 | 0.040 | TIBAL | 0.5 | 12.5 | 100 | 100 | 1800 | 0.0057 |
| s-184 | Y-3 | 0.040 | TIBAL | 0.5 | 12.5 | 100 | 100 | 1801 | 0.0059 |
| s-185 | Y-3 | 0.040 | TIBAL | 0.5 | 12.5 | 100 | 100 | 1801 | 0.0041 |
| s-186 | Y-3 | 0.040 | TIBAL | 0.5 | 12.5 | 100 | 100 | 1800 | 0.0051 |
| s-187 | Y-3 | 0.040 | TIBAL | 0.5 | 12.5 | 400 | 100 | 1800 | 0.0052 |
| s-188 | Y-3 | 0.040 | TIBAL | 0.5 | 12.5 | 400 | 100 | 1801 | 0.0045 |
| s-189 | Y-3 | 0.040 | TIBAL | 0.5 | 12.5 | 400 | 100 | 1801 | 0.0051 |
| s-190 | Y-3 | 0.040 | TIBAL | 0.5 | 12.5 | 400 | 100 | 1800 | 0.0050 |
| s-191 | Y-3 | 0.040 | TIBAL | 0.5 | 12.5 | 0 | 80 | 1800 | 0.0027 |
| s-192 | Y-3 | 0.040 | TIBAL | 0.5 | 12.5 | 0 | 80 | 1802 | 0.0023 |
| s-193 | Y-3 | 0.040 | TIBAL | 0.5 | 12.5 | 0 | 80 | 1800 | 0.0024 |
| s-194 | Y-3 | 0.040 | TIBAL | 0.5 | 12.5 | 0 | 80 | 1801 | 0.0020 |
| s-195 | Y-3 | 0.040 | TIBAL | 0.5 | 12.5 | 0 | 100 | 1800 | 0.0061 |
| s-196 | Y-3 | 0.040 | TIBAL | 0.5 | 12.5 | 0 | 100 | 1800 | 0.0053 |
| s-197 | Y-3 | 0.040 | TIBAL | 0.5 | 12.5 | 0 | 100 | 1801 | 0.0049 |
| s-198 | Y-3 | 0.040 | TIBAL | 0.5 | 12.5 | 0 | 100 | 1801 | 0.0049 |

| | Activity | | | | | | |
|---|---|---|---|---|---|---|---|
| | (g P/mmol | | | | | Tm | C8 |
| Ex# | cat · hr) | Mn | Mw | Mz | PDI | (° C.) | (wt %) |
| s-1 | 19,173 | 2,287,467 | 3,460,015 | 5,582,844 | 1.51 | 125.0 | 2.4 |
| s-2 | 695 | | | | | 128.9 | 0.8 |
| s-3 | 40,667 | 433,935 | 532,603 | 724,078 | 1.23 | 129.1 | 0.5 |
| s-4 | 39,926 | 105,013 | 131,183 | 184,782 | 1.25 | 133.9 | −0.3 |
| s-5 | 13,261 | 40,985 | 50,917 | 69,845 | 1.24 | 132.9 | 0.4 |
| s-6 | 34,615 | 326,969 | 495,086 | 784,757 | 1.51 | 129.1 | 0.7 |
| s-7 | 1,049 | 55,345 | 72,760 | 106,442 | 1.31 | 132.0 | 0.0 |
| s-8 | 1,060 | 23,501 | 29,940 | 43,175 | 1.27 | 132.1 | 0.3 |
| s-9 | 19,834 | 428,115 | 533,713 | 776,442 | 1.25 | 127.9 | 2.2 |
| s-10 | 24,735 | 90,446 | 110,864 | 153,718 | 1.23 | 135.5 | 0.8 |
| s-11 | 4,814 | 30,796 | 38,497 | 54,432 | 1.25 | 133.9 | 1.7 |
| s-12 | 53,804 | 398,194 | 570,257 | 885,057 | 1.43 | 128.1 | 0.9 |
| s-13 | 71,429 | 136,117 | 154,632 | 195,011 | 1.14 | 132.3 | 0.0 |
| s-14 | 40 | | | | | | |
| s-15 | 18,576 | 2,581,719 | 3,980,473 | 5,981,401 | 1.54 | 137.9 | |
| s-16 | 52,420 | 2,746,961 | 4,027,764 | 6,433,871 | 1.47 | | |
| s-17 | 675 | 1,754,594 | 2,943,033 | 5,298,385 | 1.68 | 137.6 | |
| s-18 | 454 | | | | | | |
| s-19 | 50,885 | 396,596 | 510,263 | 700,715 | 1.29 | 136.7 | |
| s-20 | 22,500 | 543,603 | 667,401 | 910,177 | 1.23 | 137.7 | |
| s-21 | 18,179 | 75,080 | 91,818 | 124,735 | 1.22 | 136.3 | |
| s-22 | 39,398 | 108,301 | 135,462 | 192,387 | 1.25 | 138.0 | |
| s-23 | 6,031 | 29,820 | 36,675 | 50,717 | 1.23 | 133.0 | |
| s-24 | 6,073 | 31,055 | 38,109 | 52,076 | 1.23 | 133.6 | |
| s-25 | 560 | | | | | 137.7 | |
| s-26 | 31,168 | 508,029 | 736,114 | 1,255,924 | 1.45 | 52.5 | |
| s-27 | 102,130 | 136,993 | 164,561 | 214,557 | 1.20 | 136.6 | |
| s-28 | 87,107 | 146,666 | 168,440 | 209,505 | 1.15 | 136.8 | |
| s-29 | 21,810 | 36,290 | 43,570 | 59,448 | 1.20 | 133.9 | |
| s-30 | 33,773 | 41,531 | 47,858 | 60,773 | 1.15 | 134.9 | |
| s-31 | 30,852 | 473,720 | 554,779 | 709,386 | 1.17 | 138.1 | |
| s-32 | 27,427 | 481,172 | 623,260 | 871,784 | 1.30 | 137.4 | |
| s-33 | 33,771 | 99,987 | 116,960 | 152,795 | 1.17 | 137.4 | |
| s-34 | 29,163 | 103,194 | 124,694 | 167,810 | 1.21 | 136.8 | |
| s-35 | 10,955 | 42,721 | 50,515 | 66,482 | 1.18 | 136.1 | |
| s-36 | 6,816 | 35,805 | 41,963 | 55,019 | 1.17 | 134.9 | |
| s-37 | 21,831 | 475,236 | 779,840 | 1,455,212 | 1.64 | 138.7 | |
| s-38 | 21,207 | 485,040 | 791,457 | 1,422,436 | 1.63 | 137.6 | |
| s-39 | 105,840 | 161,214 | 189,665 | 239,996 | 1.18 | 137.3 | |
| s-40 | 90,982 | 139,917 | 170,367 | 229,095 | 1.22 | 137.5 | |
| s-41 | 3,219 | 28,757 | 35,168 | 48,954 | 1.22 | 134.5 | |
| s-42 | 30,869 | 40,406 | 46,284 | 60,043 | 1.15 | 135.4 | |
| s-43 | 16,840 | 661,126 | 1,055,706 | 1,635,904 | 1.60 | 130.6 | 1.4 |
| s-44 | 30,574 | 525,962 | 821,942 | 1,404,249 | 1.56 | 129.1 | 1.1 |
| s-45 | 40,727 | 149,078 | 172,322 | 223,058 | 1.16 | 132.8 | 0.1 |
| s-46 | 22,717 | 72,128 | 79,717 | 94,551 | 1.11 | 134.6 | 0.9 |
| s-47 | 11,936 | 35,399 | 40,192 | 48,781 | 1.14 | 133.1 | −0.2 |
| s-48 | 85,345 | 152,159 | 200,551 | 262,465 | 1.32 | 130.6 | 0.5 |
| s-49 | 33,405 | 65,115 | 77,901 | 99,444 | 1.20 | 133.4 | 0.4 |
| s-50 | 29,736 | 35,976 | 42,042 | 52,077 | 1.17 | 132.7 | 0.1 |
| s-51 | 34,816 | 150,544 | 166,468 | 197,093 | 1.11 | 133.8 | 0.2 |
| s-52 | 3,520 | | | | | | |
| s-53 | 5,414 | 27,880 | 31,090 | 37,303 | 1.12 | 133.1 | 0.0 |
| s-54 | 37,781 | 127,491 | 149,201 | 184,548 | 1.17 | 132.4 | −0.1 |
| s-55 | 56,368 | 67,250 | 80,346 | 99,248 | 1.19 | 133.0 | 0.2 |
| s-56 | 41,938 | 45,865 | 53,142 | 65,845 | 1.16 | 133.3 | 0.8 |
| s-57 | 25,313 | 894,764 | 1,295,793 | 1,955,279 | 1.45 | 138.3 | |
| s-58 | 29,446 | 1,057,673 | 1,424,001 | 2,155,488 | 1.35 | 138.2 | |
| s-59 | 15,111 | 574,043 | 1,064,468 | 2,158,895 | 1.85 | 137.8 | |
| s-60 | 21,530 | 424,155 | 830,240 | 1,675,743 | 1.96 | 137.9 | |
| s-61 | 38,824 | 154,443 | 175,822 | 212,676 | 1.14 | 137.3 | |
| s-62 | 39,421 | 182,667 | 210,286 | 258,416 | 1.15 | 137.5 | |
| s-63 | 14,294 | 61,112 | 68,838 | 83,996 | 1.13 | 135.6 | |
| s-64 | 18,476 | 60,026 | 69,040 | 83,882 | 1.15 | 137.2 | |
| s-65 | 8,396 | 24,163 | 28,631 | 35,601 | 1.18 | 132.9 | |
| s-66 | 6,959 | 25,257 | 29,599 | 39,910 | 1.17 | 133.6 | |
| s-67 | −40 | | | | | | |
| s-68 | 69,985 | 153,039 | 208,356 | 279,427 | 1.36 | 137.2 | |
| s-69 | 56,125 | 81,830 | 91,170 | 108,732 | 1.11 | 137.5 | |
| s-70 | 55,603 | 75,139 | 89,043 | 110,347 | 1.19 | 137.6 | |
| s-71 | 28,575 | 33,250 | 37,885 | 47,079 | 1.14 | 134.5 | |
| s-72 | 32,083 | 34,196 | 38,382 | 46,549 | 1.12 | 134.2 | |
| s-73 | 40,886 | 159,389 | 181,781 | 218,559 | 1.14 | 137.8 | |
| s-74 | 34,513 | 155,704 | 175,169 | 211,390 | 1.13 | 137.7 | |
| s-75 | 19,358 | 56,103 | 69,074 | 86,804 | 1.23 | 136.1 | |
| s-76 | 10,610 | 60,464 | 68,110 | 81,278 | 1.13 | 136.2 | |
| s-77 | 11,268 | 35,354 | 40,316 | 48,934 | 1.14 | 134.9 | |
| s-78 | 6,651 | 29,314 | 32,598 | 38,761 | 1.11 | 133.7 | |
| s-79 | 44,058 | 143,630 | 169,664 | 211,652 | 1.18 | 137.5 | |
| s-80 | 64,394 | 154,397 | 186,080 | 232,945 | 1.21 | 137.5 | |
| s-81 | 56,077 | 80,770 | 93,185 | 113,582 | 1.15 | 136.6 | |
| s-82 | 62,074 | 72,921 | 86,303 | 107,327 | 1.18 | 136.7 | |
| s-83 | 28,711 | 31,196 | 36,260 | 43,798 | 1.16 | 134.6 | |
| s-84 | 32,636 | 33,029 | 37,091 | 44,190 | 1.12 | 134.5 | |
| s-85 | 8,011 | 988,306 | 1,978,612 | 4,446,391 | 2.00 | 127.7 | 2.6 |
| s-86 | 29,277 | 520,063 | 1,357,264 | 3,182,003 | 2.61 | 126.5 | 2.6 |
| s-87 | 310 | | | | | | |
| s-88 | 21,064 | 523,179 | 929,394 | 2,127,838 | 1.78 | 128.2 | 2.5 |
| s-89 | 39,643 | 102,023 | 140,266 | 235,109 | 1.37 | 132.0 | 2.2 |
| s-90 | 55,209 | 92,588 | 123,133 | 195,737 | 1.33 | 130.9 | 1.8 |
| s-91 | 20,901 | 106,880 | 147,442 | 239,725 | 1.38 | 133.3 | 2.2 |
| s-92 | 7,735 | 40,550 | 62,259 | 114,023 | 1.54 | 132.8 | 1.4 |
| s-93 | 30,514 | 89,350 | 129,793 | 249,393 | 1.45 | 132.2 | 1.7 |
| s-94 | 6,369 | 36,469 | 49,331 | 76,048 | 1.35 | 132.1 | 2.1 |
| s-95 | 11,876 | 3,846,308 | 4,677,619 | 6,007,505 | 1.22 | | |
| s-96 | 8,002 | 2,655,503 | 3,802,990 | 5,644,012 | 1.43 | 138.1 | |
| s-97 | 3,926 | 2,047,998 | 3,184,575 | 5,308,661 | 1.55 | 136.6 | |
| s-98 | 7,197 | 1,617,890 | 2,983,347 | 5,585,505 | 1.84 | 136.6 | |
| s-99 | 130 | | | | | | |
| s-100 | 280 | | | | | | |
| s-101 | 1,017 | 1,191,794 | 2,144,059 | 4,906,603 | 1.80 | 136.9 | |
| s-102 | 9,423 | 1,099,586 | 1,800,526 | 3,996,870 | 1.64 | 137.2 | |
| s-103 | 39,663 | 97,849 | 141,937 | 246,027 | 1.45 | 136.2 | |
| s-104 | 32,419 | 106,132 | 149,938 | 247,327 | 1.41 | 136.5 | |
| s-105 | 48,652 | 94,036 | 132,171 | 238,110 | 1.41 | 136.2 | |
| s-106 | 55,125 | 94,819 | 138,068 | 240,494 | 1.46 | 136.5 | |
| s-107 | 26,045 | 117,916 | 157,975 | 258,185 | 1.34 | 137.6 | |
| s-108 | 32,597 | 117,457 | 167,260 | 294,418 | 1.42 | 137.2 | |
| s-109 | 7,693 | 51,072 | 66,665 | 102,650 | 1.31 | 134.6 | |
| s-110 | 14,657 | 149,908 | 259,651 | 547,102 | 1.73 | 137.1 | |
| s-111 | 63,672 | 121,510 | 164,089 | 259,246 | 1.35 | 137.3 | |
| s-112 | 59,239 | 112,518 | 146,823 | 218,382 | 1.30 | 137.1 | |
| s-113 | 15,621 | 37,808 | 51,248 | 76,938 | 1.36 | 134.6 | |
| s-114 | 12,761 | 40,975 | 53,207 | 83,554 | 1.30 | 134.3 | |
| s-115 | 145 | | | | | | |
| s-116 | 130 | | | | | | |
| s-117 | 140 | | | | | | |
| s-118 | 150 | | | | | | |
| s-119 | 135 | | | | | | |
| s-120 | 130 | | | | | | |
| s-121 | 500 | 21,493 | 28,002 | 41,433 | 1.30 | 130.9 | 2.0 |
| s-122 | 500 | 20,674 | 27,771 | 48,084 | 1.34 | 130.7 | 2.1 |
| s-123 | 485 | 19,059 | 26,195 | 41,304 | 1.37 | 130.6 | 2.4 |
| s-124 | 509 | 21,552 | 31,264 | 54,705 | 1.45 | 126.8 | 3.3 |
| s-125 | 500 | 24,045 | 30,330 | 45,145 | 1.26 | 126.4 | 2.5 |
| s-126 | 460 | 19,554 | 27,502 | 43,232 | 1.41 | 126.9 | 3.9 |
| s-127 | 160 | | | | | | |
| s-128 | 135 | | | | | | |
| s-129 | 120 | | | | | | |
| s-130 | 525 | 23,108 | 30,527 | 45,897 | 1.32 | 132.5 | |
| s-131 | 470 | 19,903 | 27,452 | 42,578 | 1.38 | 132.1 | |
| s-132 | 475 | 20,009 | 27,661 | 42,980 | 1.38 | 132.6 | |
| s-133 | −13 | | | | | | |
| s-134 | 7 | | | | | | |
| s-135 | 53 | | | | | | |
| s-136 | −13 | | | | | | |
| s-137 | −10 | | | | | | |
| s-138 | −20 | | | | | | |
| s-139 | 10 | | | | | | |
| s-140 | 27 | | | | | | |
| s-141 | 7 | | | | | | |
| s-142 | 47 | | | | | | |
| s-143 | 40 | | | | | | |
| s-144 | 40 | | | | | | |
| s-145 | −13 | | | | | | |
| s-146 | −17 | | | | | | |
| s-147 | −17 | | | | | | |
| s-148 | 13 | | | | | | |
| s-149 | 0 | | | | | | |
| s-150 | 3 | | | | | | |
| s-151 | 53 | | | | | | |
| s-152 | 33 | | | | | | |
| s-153 | 60 | | | | | | |
| s-154 | 7 | | | | | | |
| s-155 | 13 | | | | | | |
| s-156 | 57 | | | | | | |
| s-157 | 3 | | | | | | |
| s-158 | −20 | | | | | | |
| s-159 | −20 | | | | | | |
| s-160 | 150 | | | | | | |
| s-161 | 30 | | | | | | |
| s-162 | 13 | | | | | | |
| s-163 | 57 | | | | | | |
| s-164 | 50 | | | | | | |
| s-165 | 63 | | | | | | |
| s-166 | −10 | | | | | | |
| s-167 | −17 | | | | | | |
| s-168 | −20 | | | | | | |
| s-169 | 20 | | | | | | |
| s-170 | 17 | | | | | | |
| s-171 | 13 | | | | | | |
| s-172 | 47 | | | | | | |
| s-173 | 47 | | | | | | |
| s-174 | 57 | | | | | | |
| s-175 | 125 | | | | | | |
| s-176 | 110 | | | | | | |
| s-177 | 110 | | | | | | |
| s-178 | 100 | | | | | | |
| s-179 | 110 | | | | | | |
| s-180 | 100 | | | | | | |
| s-181 | 95 | | | | | | |
| s-182 | 100 | | | | | | |
| s-183 | 285 | | | | | | |
| s-184 | 295 | | | | | | |
| s-185 | 205 | | | | | | |
| s-186 | 255 | | | | | | |
| s-187 | 260 | | | | | | |
| s-188 | 225 | | | | | | |
| s-189 | 255 | | | | | | |
| s-190 | 250 | | | | | | |
| s-191 | 135 | | | | | | |
| s-192 | 115 | | | | | | |
| s-193 | 120 | | | | | | |
| s-194 | 100 | | | | | | |
| s-195 | 305 | | | | | | |
| s-196 | 265 | | | | | | |
| s-197 | 245 | | | | | | |
| s-198 | 245 | | | | | | |

As can be seen in Table 8, an increase in the ratio of scavenger to catalyst causes a decrease in polymer molecular weight. Typically, and especially at higher polymerization temperatures, the molecular weight distribution also decreases with increasing scavenger to catalyst molar ratio.

Overall, bis(phenolate)-type catalyst systems of the present disclosure based on rare earth elements can be used for producing copolymers of ethylene and butadiene under mild conditions with high conversions. The catalyst systems disclosed herein are attractive options for implementation into industrial scale processes for the high throughput production of copolymer materials, e.g., derived from ethylene and butadiene monomers, having tailorable physical properties, polymer backbone architecture, and varying functional moieties. In addition, polar side chain moieties can be incorporated into the polymer chains over the course of copolymerization. Such functionalized polymers can be desirable for the tire industry due to enhanced interactions between the copolymer and filler(s) present with the copolymer during use as a tire material.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A process for producing an ethylene copolymer, the process comprising:
polymerizing ethylene and an optional comonomer selected from the group consisting of C₃-C₂₂ alpha-olefin, C₄-C₄₀ conjugated diene, C₅-C₂₀ cyclic olefin, C₆-C₆₀ metal hydrocarbenyl transfer agent, and combinations thereof by introducing the ethylene, a chain transfer agent, and the optional comonomer with a catalyst system to form the ethylene copolymer, wherein the catalyst system comprises a compound represented by Formula (I): 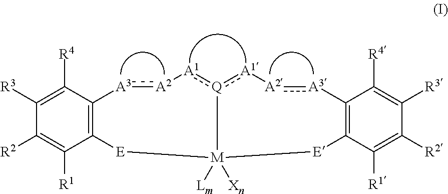
wherein:
M is a group 3 transition metal or a lanthanide metal;
E and E′ are each independently oxygen, sulfur, or NR^{A} wherein R^{A} is independently hydrogen, C₁-C₄₀ hydrocarbyl, substituted C₁-C₄₀ hydrocarbyl, or a heteroatom-containing group;
Q is a group 14 atom, group 15 atom, or group 16 atom;
A¹QA^{1′} are part of a heterocyclic Lewis base containing 4 to 40 non-hydrogen atoms that links A² to A^{2′} via a 3-atom bridge with Q being central atom of the 3-atom bridge;
each of A¹ and A^{1′} is independently carbon, nitrogen, or C(R^{B}), wherein R^{B} is selected from hydrogen, C₁-C₂₀ hydrocarbyl, substituted C₁-C₂₀ hydrocarbyl, or heteroatom containing hydrocarbyl; 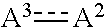
is a divalent group containing 2 to 40 non-hydrogen atoms that links A¹ to the E-bonded aryl group shown in Formula (I) via a 2-atom bridge, and A³ and A² are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings; 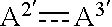
is a divalent group containing 2 to 40 non-hydrogen atoms that links A^{1′} to the E′-bonded aryl group shown in Formula (I) via a 2-atom bridge, and A^{3′} and A^{2′} are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;
each L is independently a Lewis base;
X is an anionic ligand;
any two or more L groups may be joined together to form a polydentate Lewis base;
an X group may be joined to an L group to form a monoanionic bidentate group;
n is 1;
m is 0, 1, or 2;
n+m is not greater than 3; and
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
obtaining the ethylene copolymer.

2. The process of claim 1, wherein M is selected from the group consisting of Sc, Y, La, Lu, and Nd.

3. The process of claim 1, wherein each of E and E′ is oxygen, Q is nitrogen, and each of A¹ and A^{1′} are carbon.

4. (canceled)

5. (canceled)

6. The process of claim 1, wherein:
A³ and A² are combined to form a first ortho-phenylene that is optionally substituted, and
A^{3′} and A^{2′} are combined to form a second ortho-phenylene that is optionally substituted.

7. The process of claim 1, wherein:
A³ and A² are combined to form a first group selected from the group consisting of indolene, substituted indolene, benzothiophene, substituted benzothiophene, pyrrolene, substituted pyrrolene, thiophene, and substituted thiophene, and
A^{3′} and A^{2′} are combined to form a second group selected from the group consisting of indolene, substituted indolene, benzothiophene, substituted benzothiophene, pyrrolene, substituted pyrrolene, thiophene, and substituted thiophene.

8. (canceled)

9. The process of claim 1 wherein the compound is represented by Formula (III), Formula (IV), or Formula (V): 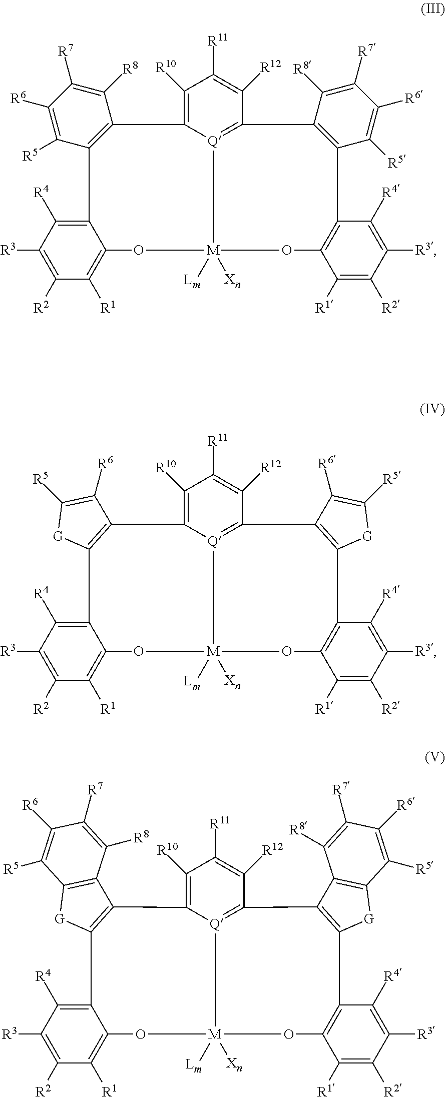
wherein M, L, X, m, n, R¹, R², R³, R⁴, R^{1′}, R^{2′}, R^{3′}, and R^{4′} are defined as in claim 1;
Q′ is a group 15 heteroatom;
each of R⁵, R⁶, R⁷, R⁸, R^{5′}, R^{6′}, R^{7′}; R^{8′}, R¹⁰, R¹¹, and R¹² of Formula (III), Formula (IV), or Formula (V) is independently hydrogen, C₁-C₄₀ hydrocarbyl, substituted C₁-C₄₀ hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
each G of Formula (III), Formula (IV), or Formula (V) is a group 15 or 16 heteroatom or heteroatom group selected from S, O, NR′, PR′ where R′ is selected from hydrogen atoms and C₁-C₄₀ hydrocarbyl or substituted hydrocarbyl groups.

10. The process of claim 9, wherein each of R^{1′} and R¹ of Formula (I), Formula (III), Formula (IV), or Formula (V) is independently a cyclic tertiary alkyl group or a substituted cyclic tertiary alkyl group, an acyclic tertiary alkyl group or a substituted acyclic tertiary alkyl group.

11. The process of claim 10, wherein each of R^{1′} and R¹ of Formula (I), Formula (III), Formula (IV), or Formula (V) is independently selected from the group consisting of adamantan-1-yl, substituted adamantan-1-yl, tert-butyl, tert-pentyl, substituted tert-butyl, or substituted tert-pentyl.

12. (canceled)

13. (canceled)

14. The process of claim 9, wherein each of R³ and R^{3′} of Formula (I), Formula (III), Formula (IV), or Formula (V) is independently a substituted C₁-C₂₀ alkyl or unsubstituted C₁-C₂₀ alkyl.

15. The process of claim 14, wherein each of R³ and R^{3′} of Formula (I), Formula (III), Formula (IV), or Formula (V) is independently methyl or tert-butyl.

16. The process of claim 9, wherein each of R², R⁴, R^{2′}, R^{4′}, R⁵, R⁶, R⁷, R⁸, R^{5′}, R^{6′}, R^{7′}; R^{8′}, R¹⁰, R¹¹, and R¹² of Formula (I), Formula (III), Formula (IV), or Formula (V) is hydrogen.

17. The process of claim 9, wherein X of Formula (I), Formula (III), Formula (IV), or Formula (V) is independently dimethylamido, diethylamido, bis(dimethylsilyl)amido, bis(trimethylsilyl) amido, or methylenetrimethylsilyl, and/or each L of Formula (I), Formula (III), Formula (IV), or Formula (V) is tetrahydrofuran.

18. (canceled)

19. The process of claim 1, wherein the process comprises introducing the C₄-C₄₀ conjugated diene with the catalyst system, wherein the C₄-C₄₀ conjugated diene is selected from the group consisting of isoprene, 1,3-butadiene, and combinations thereof, wherein the ethylene copolymer comprises C₄-C₄₀ conjugated diene units.

20. (canceled)

21. The process of claim 1, wherein the ethylene copolymer has about 0.1 mol % to about 10 mol % 1,2-cyclopentane units.

22. The process of claim 1, wherein the process comprises introducing the C₆-C₆₀ metal hydrocarbenyl transfer agent with the catalyst system, wherein the ethylene copolymer further comprises C₆-C₆₀ metal hydrocarbenyl transfer agent units.

23. The process of claim 22, wherein the C₆-C₆₀ metal hydrocarbenyl transfer agent is selected from the group consisting of tri(but-3-en-1-yl)aluminum, tri(pent-4-en-1-yl)aluminum, tri(oct-7-en-1-yl)aluminum, tri(non-8-en-1-yl)aluminum, tri(dec-9-en-1-yl)aluminum, dimethyl(oct-7-en-1-yl)aluminum, diethyl(oct-7-en-1-yl)aluminum, dibutyl(oct-7-en-1-yl)aluminum, diisobutyl(oct-7-en-1-yl)aluminum, diisobutyl(non-8-en-1-yl)aluminum, diisobutyl(dec-9-en-1-yl)aluminum, diisobutyl(dodec-11-en-1-yl)aluminum, and combinations thereof.

24. The process of claim 1 conducted in a reactor, at a reactor pressure of 0.05 MPa to 1,500 MPa and a reactor temperature of 30° C. to 230° C.

25. A tire material comprising:
a composition comprising:
about 10 pounds per hundred rubber (phr) to about 150 phr filler; and
a copolymer having:
ethylene units,
conjugated diene units,
about 0.1 mol % to about 10 mol % 1,2-cyclopentane units, and
functionalized vinyl transfer agent units.

26. The tire material of claim 25, wherein the conjugated diene of the conjugated diene units is 1,3-butadiene, and/or the functionalized vinyl transfer agent units are carbon dioxide functionalized vinyl transfer agent units, and/or the filler is silica.

27. (canceled)

28. (canceled)

29. The process of claim 1, wherein the process comprises introducing the C₃-C₂₂ alpha-olefin with the catalyst system.

30. (canceled)

31. (canceled)

32. The process of claim 1, wherein the chain transfer agent is an alumoxane, zinc alkyl, or aluminum alkyl.

33. (canceled)

34. The process of claim 1, wherein a molar ratio of chain transfer agent to catalyst is from 1:1 to 1,000:1.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. The process of claim 1, wherein the catalyst system further comprising a support material.
